(19) United States
(12) Patent Application Publication
(10) Pub. No.: US 2016/0061304 A1
(43) Pub. Date: Mar. 3, 2016

(54) VEHICLE GEARBOX

(71) Applicant: ZF FRIEDRICHSHAFEN AG, Friedrichshafen (DE)

(72) Inventors: Johannes KALTENBACH, Friedrichshafen (DE); Peter ZIEMER, Tettnang (DE); Kai BORNTRAGER, Langenargen (DE)

(21) Appl. No.: 14/778,258

(22) PCT Filed: Feb. 18, 2014
(86) PCT No.: PCT/EP2014/053052

§ 371 Date: Sep. 18, 2015

(30) Foreign Application Priority Data
Mar. 20, 2013 (DE) 10 2013 204 918.8

(51) Int. Cl. F16H 37/04; F16H 3/66; B60K 6/365; F16H 3/00

(52) U.S. Cl. CPC F16H 37/042; F16H 3/006; F16H 3/66; B60K 6/365; F16H 2003/445

(57) ABSTRACT

A vehicle transmission with a drive shaft (AW), two transmission input shafts (GE1, GE2), at least one decoupling element (K2, X1), which is assigned to the second transmission input shaft (GE2), a main shaft (HW), an output shaft (AV) and at least three planetary gear sets (PG1, PG2, PG3). A respective subtransmission (TG1, TG2) is assigned to each of the transmission input shafts (GE1, GE2). One of the two subtransmissions (TG1, TG2) includes at least the first planetary gear set (PG1) while the other of the two subtransmissions (TG1, TG2) includes at least the second planetary gear set (PG2). The shafts (AB, AW, GE1, GE2, HW) are or can be operatively connected to the three planetary gear sets such that at least seven forward gears can be shifted to by the two subtransmissions (TG1, TG2). One of these gears can be shifted as a direct gear or another as an overdrive gear.

This application is a National Stage completion of PCT/EP2014/053052 filed Feb. 18, 2014, which claims priority from German patent application serial no. 10 2013 204 918.8 filed Mar. 20, 2013.

### FIELD OF THE INVENTION

The invention relates to a vehicle transmission.

### BACKGROUND OF THE INVENTION

Increasing demands on the power of vehicles, with the greatest possible efficiency and low fuel consumption as well as with low pollution emissions, have led to a comparatively large number of gears in transmissions in the field of passenger vehicles as well as in the field of commercial vehicles. At the same time, the available construction space is limited and the weight of the transmission should be increased only slightly or not at all in comparison with existing designs. Furthermore, there is a search for transmissions that enable gear changing without an interruption in tractive force, while being inexpensive to manufacture and being usable in a variety of drive concepts with relatively little effort.

There are known vehicle transmissions having two subtransmissions, for example, double clutch transmissions. With these transmissions, two clutches, which are usually friction-locking at the input end, together with one or more gear planes or gear sets, form a subtransmission, each having one power path. These clutches have preselected and active gear changes, resulting in a power shiftable gear change sequence due to overlapping engagement and disengagement of the clutches in sequential shifting.

Double clutch transmissions may also be designed as group transmissions. Such group transmissions have a multi-gear main group, usually in a reduction gearing design, as well as a splitter group, which is active as a split transmission, and/or a range group, which is active as a range transmission, in a reduction gearing or planetary design. It is therefore readily possible to multiply the number of gears of the transmission in this way.

There are also known double clutch transmissions in planetary design. DE 10 2004 014 081 A1 discloses one such double clutch transmission having only one transmission input shaft, with which three planetary gear sets and two friction-locking shift elements and a plurality of form-locking shift elements are situated, the friction-locking shift elements being active for connecting various power paths, and the form-locking shift elements being active for setting various transmission ratio steps in the power paths, and in which a total of seven forward gears and one reverse gear can be used. In one subsection of the gears, gear changing without an interruption in tractive force can be implemented by means of the friction-locking shift elements.

DE 10 2010 028 026 A1 discloses a hybrid drive train for a vehicle with an internal combustion engine and one or more electric machines, in which one transmission has two subtransmissions in a reduction gearing design. One electric machine or one each is assigned to one or both subtransmissions. At least one electric machine of a subtransmission is operatively connectable to the internal combustion engine by means of a form-locking shift element.

DE 10 2012 201 366 A1 by the present applicant, not published previously, discloses a hybrid drive train for a motor vehicle having an internal combustion engine and at least one electric machine, in which one transmission has at least one transmission input shaft, one transmission output shaft and three planetary gear sets, wherein two power paths or subtransmissions, respectively, are each designed with a fixed input transmission ratio between one drive and the second planetary gear set, and in which the first planetary gear set is assigned to the first or second power path. The drive-active electric machine is assigned to the first power path and can be brought into operative connection with the transmission input shaft, or the internal combustion engine, respectively by means of a claw clutch or a claw brake. In addition, the second planetary gear set can be connected to the first and second power paths. The third planetary gear set can be connected in turn to the second power path and to the second planetary gear set and is constantly in drive connection to the transmission output shaft at the output end.

To implement six to eight sequentially power shiftable forward gears, seven to nine shift elements are situated, preferably embodied as form-locking shift elements, wherein the shift elements are predominantly combined as bidirectional shift elements or shift packages, respectively, each having two shift positions, which can be actuated reciprocally by an actuator. With a possible geometrically stepped shift system of this transmission, the claw clutch or claw brake, which connects the drive-active electric machine to the transmission input shaft, is disengaged and engaged sequentially. In an engaged clutch state, drive operation by internal combustion engine is obtained in the odd gears. In a disengaged clutch state, there is drive operation by electric machine in the odd gears and drive operation by an internal combustion engine in the even gears. With the gear changes, power shifting is performed by means of the electric motor-driven gears as supporting gears.

### SUMMARY OF THE INVENTION

Against this background, the object of the invention is to create a vehicle transmission, which permits a comparatively large number of gear changes without an interruption in tractive force, such that they can be manufactured inexpensively and can be used for both conventional and hybrid drive trains.

This object is achieved through the features, while advantageous embodiments and refinements of the invention as described below.

The invention is based on the finding that a vehicle transmission, consisting of a plurality of planetary gear sets, which can be coupled to one another, can be operated by a suitable linking to two transmission input shafts in an internal combustion engine drive train and can be operated in a hybrid drive train, wherein the transmission input shafts can be coupled to the drive machine(s) by means of decoupling clutches or decoupling brakes. The planetary gear sets permit a large number of gears in a compact design using relatively few gear planes. Two transmission input shafts can be used in particular to form a double clutch transmission having two independent power paths, so that a power shiftable sequential gear sequence can be implemented. A hybrid drive can be implemented by linking an electric machine to one of the two transmission input shafts. A shiftable coupling of the power paths to one another can also expand the transmission ratio and drive options.

The invention is thus directed at a vehicle transmission with a drive shaft, with a first and a second transmission input shaft, with at least one decoupling element, which is assigned to the second transmission input shaft, with a main shaft, with an output shaft and with at least one first, second and third planetary gear sets, comprising as elements at least one ring gear, one sun gear and one planet carrier with planet gears, as well as with a plurality of shift elements for shifting transmission ratios or drive connections. One subtransmission is assigned to each of the two transmission input shafts, and one of the two subtransmissions has at least the first planetary gear set, and the other of the two subtransmissions has at least the second planetary gear set.

To solve the problem as formulated, it is also provided that the first planetary gear set is positioned upstream from the two transmission input shafts with regard to the drive technology, a first one of the elements of the first planetary gear set, which is active as its drive element, being connected or connectable directly or indirectly to the drive shaft at the drive end and connectable to the second transmission input shaft by means of the at least one decoupling element at the transmission end, wherein a second one of the elements of the first planetary gear set, which is active as its output element, is connected or connectable to the first transmission input shaft at the transmission end, in which the first transmission input shaft is connectable to the second transmission input shaft or at least to the main shaft, the two transmission input shafts can be operatively connected to one or both of the second and third planetary gear sets, and the main shaft is connected to the output shaft or at least to one of the elements of the third planetary gear set, and it is possible to shift to at least seven sequentially power shiftable forward gears by means of the two subtransmissions, one of these forward gears being a direct gear or an overdrive gear.

A vehicle transmission that can be used in a drive train of the hybrid vehicle (hybrid transmission) as well as in conventional power shifting transmissions is created by this configuration, this power-shifting gear having a relatively large number of gears and a comparatively simple and compact design. The gears of the various embodiments of this vehicle transmission are completely or at least largely power shiftable, which thus results in a comfortable driving operation. The vehicle transmission has two input shafts, each forming two independent power paths or subtransmissions, respectively, which are independent of one another, each with one of the first two planetary gear sets, wherein one gear in the respective subtransmission under no load can be preselected, while the other subtransmission is currently transmitting the applied power. It is thus possible to switch to two mutually independent power paths between the drive and the second planetary gear set. A third planetary gear set, which is downstream from the power paths with regard to the drive technology, can be used flexibly, with the two subtransmissions individually or together in operative connection.

The proposed vehicle transmission can be operated as a dual-input-shaft transmission, for example, with two input friction clutches or one input clutch and one input brake for selective connection of the subtransmissions, wherein the drive torque of an internal combustion engine is transmitted to the respective subtransmission. However, it is also possible that one of the two subtransmissions can be driven directly in an electric mode by an electric machine, wherein a form-locking clutch can fulfill the function of a coupling element or a decoupling element, respectively, to the other subtransmission or to an internal combustion engine. A reverse driving operation can be implemented by reversing the direction of rotation of the electric drive in the case of a hybrid drive train.

In a conventional drive, i.e. with only an internal combustion engine, a reversing gear transmission may be provided for reversing the direction of rotation for implementation of reverse transmission ratios and can be used in various locations in the proposed transmission structure. In addition, the configuration permits on-demand coupling of the two subtransmissions to one another, which can be used to advantage for implementation of direct gears and/or overdrive gears in particular. The highest gear is preferably shiftable as a direct gear or an overdrive gear. Furthermore, a simple expansion of the transmission is possible with an additional transmission group, which can be coupled to the main transmission.

The vehicle transmission according to the invention can thus be introduced in a very flexible manner into a hybrid drive train, a double clutch transmission drive train, a group transmission drive train or combinations thereof in the fields of both passenger vehicles and commercial vehicles.

According to a preferred embodiment of the invention, it is possible to provide that the vehicle transmission is designed as a double clutch transmission with a first decoupling element and a second decoupling element, which are designed as friction clutches; the first friction clutch is connected at the input end to the ring gear of the first planetary gear set, which is active as its output element; the first friction clutch is connected at the output end to the first transmission input shaft; the second friction clutch is connected at the input end to the planet carrier of the first planetary gear set, which is active as its drive element; and the second friction clutch is connected at the output end to the second transmission input shaft.

The vehicle transmission can thus be designed as a double clutch transmission with two subtransmissions in planetary design. The drive shaft, the two friction clutches with the two transmission input shafts, the main shaft, the output shaft and the planetary gear sets may preferably be situated in a compact coaxial configuration in which a plurality of shaft planes are situated one above the other; shift elements that can be operated for variable coupling of transmission elements and/or shafts of the gear sets of shift actuators are situated on these shift elements.

The proposed transmission structure permits a gear sequence, in which the gears can be stepped geometrically, for example, i.e., with a difference in the maximum speed in the gears that increases with the shift sequence. The transfer of power from the active gear to the next gear may take place through an overlapping engagement and disengagement of the two friction clutches and/or decoupling elements, wherein a gear change without an interruption in tractive force can be implemented.

A configuration for such a double clutch transmission, which has been evaluated as an advantageous basic gear set, can be implemented by the fact that the three planetary gear sets are shiftable by means of a first, a second and a third shift element, each with two shift positions, and by means of a fourth shift element with one shift position;

with the first planetary gear set, the ring gear can be connected to the first transmission input shaft by means of the first decoupling element; the sun gear is or can be locked on a rotationally fixed component, and the planet carrier can be connected to the second transmission input shaft by means of the second decoupling element;

with the second planetary gear set, the ring gear can be connected to the first transmission input shaft by means of the first shift element, and the sun gear is or can be locked onto a rotationally fixed component to the second transmission input shaft by means of the second shift element, and the planet carrier can be connected to the second transmission input shaft by means of the second shift element and to the planet carrier of the third planetary gear set by means of the third shift element;

with the third planetary gear set, the ring gear is or can be locked onto a rotationally fixed component, the sun gear can be connected to the planet carrier of the second planetary gear set by means of the third shift element and to the first transmission input shaft by means of the first shift element, and the planet carrier is connected to the output shaft;

the main shaft is connected directly to the output shaft;

it is possible to shift to eight forward gears, which are sequentially power shiftable by means of the first and second decoupling elements;

wherein the seventh gear can be shifted as a direct gear, to which it is possible to shift by means of the second decoupling element, the second shift element and the third shift element;

and the eighth gear is an overdrive gear, to which it is possible to shift by means of the first decoupling element and the fourth decoupling element, wherein a direct connection of the first transmission input shaft to the main shaft can be established by means of the fourth shift element.

It should be pointed out here that a shift element may comprise both a single shift device as well as a plurality of shift devices combined into so-called shift packages. A shift position is understood to be a position of a shift element, in which a force-locking connection of two components exists or is established by the shift element. A shift element having two shift positions, for example, may thus alternately establish or release a first or a second force-locking connection. A shift element also has a neutral position in which it is positioned without a connection. The shift elements may be designed as inexpensive form-locking claw shift elements.

With the basic gear set described here, the first planetary gear set belongs to the first subtransmission, which is defined by the first friction clutch and the first transmission input shaft, and the second planetary gear set belongs to the second subtransmission, which is defined by the second friction clutch and the second transmission input shaft. Since one of the elements of the planet gear, namely the sun gear, is locked or at least can be locked on a rotationally fixed component in the case of the first and second planetary gear sets, and since a second element, namely the ring gear, is or can be connected to the first and/or second transmission input shafts, the two first planetary gear sets act as input constants of their subtransmissions, each having a respective fixed transmission ratio.

A power shiftable sequential gear sequence is obtained by combining the planetary gear set transmission ratios in such a way that the respective next gear can be preselected while not under load, and the power transfer is achieved by deactivating the respective one power path and activating the other respective power path by means of the decoupling elements and/or friction clutches.

Due to the configuration of this basic gear set, a compact double clutch transmission with one direct gear and one overdrive gear is implemented, wherein the direct gear is switchable by means of the second clutch, and the overdrive gear is shiftable by means of the first clutch. This configuration thus permits eight power shiftable forward gears with three planetary gear sets and four shift elements, having a total of seven shift positions. The transmission ratios are preferably geometrically stepped.

Since the transmission ratio of the first planetary gear set is connected upstream from the first transmission input shaft with regard to the drive technology, the result is not the direct gear due to the direct connection of the first transmission input shaft by means of the main shaft to the output shaft in this configuration, but instead is the overdrive gear. For establishing the direct connection of the first transmission input shaft to the main shaft and to the output shaft, which is fixedly connected to the main shaft in this first embodiment, only the fourth shift element is necessary. In this embodiment, this shift element is also required only to establish this direct connection.

The overdrive gear has only minor drag losses. This is achieved in that the main shaft leads directly to the output drive, wherein the second planetary gear set and its shiftable coupling at the drive end and at the output drive end are implemented at higher shaft planes, i.e., at shaft planes, which are situated coaxially higher than a shaft plane that is defined by the drive shaft, the first transmission input shaft, the main shaft and the output shaft.

The planetary gear sets may be designed as simple minus transmissions, i.e., as epicyclic gears with a minus stationary transmission ratio, wherein the stationary transmission ratio is given by the transmission ratio of two planetary assembly elements with a locked planet carrier, and the number of teeth of the ring gears and/or gears with internal teeth have a minus sign according to the conventional standard. The two rotating elements in the case of the stationary transmission ratio, i.e., the ring gear and the sun gear, have opposite directions of rotation. However, if the planet carrier is used as a drive element or output element and one of the two other elements, for example, the sun gear, is locked in place, this yields the same direction of rotation between the drive and the output. Plus planetary gear sets are fundamentally also possible for the vehicle transmission, in which case the planet carrier and ring gear linkings are then to be reversed because the ring gear and the sun gear here still have the same directions of rotation because of double planet gear rows. The stationary transmission ratio is then increased by the absolute amount of 1 in comparison with a corresponding minus gear.

To further simplify the basic gear set, it is possible to provide that the three planetary gear sets are shiftable by means of the first, second and third shift elements, each with two shift positions, and by means of the fourth shift element with one shift position;

with the first planetary gear set, the ring gear can be connected to the first transmission input shaft by means of the first decoupling element, the sun gear is or can be locked on a rotationally fixed component, and the planet carrier can be connected to the second transmission input shaft by means of the second decoupling element;

with the second planetary gear set, the ring gear can be connected to the first transmission input shaft by means of the first shift element and to the second transmission input shaft by means of the second shift element, the sun gear is or can be locked on a rotationally fixed component, and the planet carrier can be connected to the second transmission input shaft by means of the second shift element and to the planet carrier of the third planetary gear set by means of the third shift element;

with the third planetary gear set, the ring gear is or can be locked on a rotationally fixed component, the sun gear can be connected to the planet carrier of the second planetary gear set by means of the third shift element and to the first transmission input shaft by means of the first shift element, and the planet carrier is connected to the output shaft;

the main shaft is connected to the sun gear of the third planetary gear set;

it is possible to shift to eight forward gears, which are sequentially power shiftable by means of the first and second decoupling elements;

the seventh gear can be shifted as a direct gear, to which it is possible to shift by means of the second decoupling element, and the second shift element as well as the third shift element;

wherein the eighth gear is an overdrive gear, to which it is possible to shift by means of the first decoupling element and by means of the second, third and fourth shift elements;

wherein a connection of the first transmission input shaft to the second transmission input shaft can be established by means of the fourth shift element.

Thus, an overdrive gear is created with this basic gear set, by a coupling of the two subtransmissions instead of a direct connection of the first transmission input shaft to the main shaft. This makes it possible to eliminate one shaft plane in the region of the main shaft between the second and third planetary gear sets.

This can be implemented in particular, in that the torque output elements of all three planetary gear sets are shifted in succession for shifting the overdrive gear, wherein the first transmission input shaft can be connected at the drive end to the output element of the first planetary gear set by means of the first decoupling element and at the output end, the third output element is connected to the output shaft of the transmission, so that the planetary gear sets are coupled to one another, but only the transmission ratio of the first planetary gear set is effective with respect to the output. The actual subtransmission coupling then takes place by way of the fourth shift element. In addition, the second and third shift elements are to be engaged for implementation of the direct gear and the overdrive gear.

According to another embodiment of the invention, it is possible to provide that the three planetary gear sets are each shiftable by means of the first, second and third shift elements, each with two shift positions;

with the first planetary gear set, the ring gear can be connected to the first transmission input shaft by means of the first decoupling element, the sun gear is or can be locked on a rotationally fixed component, and the planet carrier can be connected to the second transmission input shaft by means of the second decoupling element;

with the second planetary gear set, the ring gear can be connected to the first transmission input shaft by means of the first shift element and can be connected to the second transmission input shaft by means of the second shift element, the sun gear is or can be locked on a rotationally fixed component, and the planet carrier can be connected to the second transmission input shaft by means of the second shift element and to the planet carrier of the third planetary gear set by means of the third shift element;

with the third planetary gear set, the ring gear is or can be locked on a rotationally fixed component, the sun gear is connected to the planet carrier of the second planetary gear set by means of the third shift element and can be connected to the first transmission input shaft by means of the first shift element, and the planet carrier is connected to the output shaft;

the main shaft is connected to the sun gear of the third planetary gear set;

seven forward gears are shiftable, these gears being sequentially power shiftable by means of the first and second decoupling elements;

wherein the seventh gear is a direct gear, to which it is possible to shift by means of the second decoupling element and by means of the second and third shift elements.

Thus, it is possible to shift to seven forward gears by means of this basic gear set with only three double shift elements. Since a fourth shift element is necessary only for the subtransmission coupling in the eighth gear, a particularly lightweight and compact seven-gear double clutch transmission can be constructed by simply omitting this shift element. The seventh gear, as the highest gear, can be shifted as a direct gear with this transmission.

Furthermore, it is possible to provide that an additional shift element is situated therein, so that by means of this shift element, the ring gear with the third planetary gear set can be alternately releasably locked on a rotationally fixed component or connected to the planet carrier.

Thus, with the basic gear set, the linking of the ring gear of the third planetary gear set can be implemented by an additional shift element as a releasable connection. The ring gear is locked in those gears in which the transmission ratio of the third planetary gear set is required. In gears in which the transmission ratio of the third planetary gear set is not required, the shifting of a direct drive of the third planetary gear set is made possible with the ring gear released instead of free rotation of the planet gears and/or the sun gear. Therefore, unnecessary bearing losses by free-wheeling gears can be prevented in the respective gears. Direct drive can be achieved by the fact that the additional shift element has a second shift position in addition to the shift position for locking the ring gear, the second shift position being for a connection of two elements of the planetary gear set, for example, connecting the ring gear to the planet carrier. In this shift position, the additional shift element ensures rotational speed ratios on the third planetary gear set, which are defined by the direct drive, without carrying the load itself.

It is fundamentally also possible to achieve a direct drive when the ring gear is released, through suitable combinations of shift positions of other shift elements, which are present anyway, and to omit the second shift position, inasmuch as this is allowed and expedient due to a possible shift pattern of the transmission.

Furthermore, with the first two planetary gear sets as well, it is also possible to design the locked element, i.e., in particular the sun gear, to be detachably connectable to the rotationally fixed component, or the transmission casing, respectively, by an additional shift element in each case, and to thereby enable a direct drive, to reduce bearing losses.

To eliminate additional construction space and weight, neighboring shift elements, which are never engaged at the same time in the shift patterns that are possible or at least provided, are combined to yield shift elements with a plurality of shift positions, which are actuated alternately by means of a single actuator and can be combined as shift packages. It is known that bidirectionally operative and/or double-acting shift elements, each having two shift positions and one neutral position in between, are often used in various transmissions. The transmission structure according to the invention also permits triple-shift elements.

It is thus possible to provide that, in the second embodiment of the basic gear set in particular, for example, the respective first and fourth shift elements are combined into a single shift element with three shift positions. This is possible because the fourth shift element is needed only for the subtransmission coupling in the highest gear. As a result, an additional advantage is obtained with regard to construction space and weight.

Another advantage with regard to the construction space can be achieved by the fact that the second planetary gear set is situated radially above the third planetary gear set, so that these two planetary gear sets form an axially nested construction. Therefore, one gear plane can be eliminated, and thus the transmission structure can be shortened axially.

Furthermore, it is possible to provide that a first decoupling element and a second decoupling element are situated in the vehicle transmission, such that the first decoupling element is designed as a brake, by means of which the sun gear of the first planetary gear set can be braked on or released from a rotationally fixed component (GH); the second decoupling element is designed as a friction clutch, which is connected at the input end to the planet carrier of the first planetary gear set, which is active as its drive element and is connected at the output end to the second transmission input shaft, and in which the ring gear of the first planetary gear set, which is active as its output element, is connected to the first transmission input shaft.

Thus, instead of two friction clutches, one friction clutch and one brake may be used as an alternative. This is possible because the first planetary gear set is active as an input constant of the first subtransmission. Accordingly, instead of a first clutch for activating the gears of the first subtransmission, the brake is engaged and thus the sun gear is braked and the second clutch is disengaged, while the second clutch is engaged to activate the gears of the second subtransmission, and the brake is released for a no-load preselection of the respective next gear. The brake thus assumes the function of the first decoupling element. Both embodiments, i.e., with two friction clutches or with one friction clutch and one brake, the shift pattern of the transmission may be the same.

To implement at least one reverse gear in the vehicle transmission in the case of a driving operation using only an internal combustion engine, an even simpler planetary gear set may be situated in the same, acting as a reversing gear set for reversing the direction of rotation between the drive and the output drive. The reversing gear set can be integrated into the transmission structure in various locations.

According to another embodiment of the invention, it is possible in this regard to provide that, for implementation of up to eight reversing gears, a fourth planetary gear set, which is active as a reversing gear set, and a fifth shift element, which has two shift positions, are situated axially in front of the first planetary gear set and upstream from it with regard to the drive technology, such that in the case of the fourth planetary gear set, the ring gear is connected to the planet carrier of the first planetary gear set, the sun gear is connected to the drive shaft and the planet carrier is alternately lockable on a rotationally fixed component by means of the fifth shift element or connectable to the sun gear of the fourth planetary gear set.

The reversing gear set is thus integrated into the transmission at the transmission input, upstream from the first planetary gear set and the decoupling elements in the flow of power. The eight reverse gears are sequentially power shiftable by means of the two decoupling clutches. The fifth shift element serves to shift between the reverse gear transmission ratios and the forward gear transmission ratios.

This configuration permits eight reverse gears, which may have comparatively low transmission ratios. For example, the reverse gears may have a transmission ratio approximately 1.5 times higher than the corresponding forward gears. In particular it is thus possible to implement reverse gears, which generate a very low driving speed when a drive machine designed as an internal combustion engine is idling, so that when the friction clutch is completely engaged and the gas pedal has not been actuated, comfortable and sensitive maneuvering in reverse is possible by merely operating the brake pedal. Because of the low transmission ratio of the driving torque, a torque limitation of the internal combustion engine in the reverse gears is reasonable to limit the load on the transmission.

In another preferred embodiment of the invention, it is possible to provide that, to implement up to four reverse gears, a fourth planetary gear set, which is active as a reversing gear set, and a fifth shift element, which has two shift positions, may be situated axially between the first planetary gear set and the second planetary gear set as well as being situated upstream from the second planetary gear set with regard to the drive technology, such that the ring gear can be connected alternately to the ring gear or to the planet carrier of the second planetary gear set by means of the second shift element, the sun gear of the fourth planetary gear set is connected to the second transmission input shaft, and the planet carrier is alternately lockable on a rotationally fixed component by means of the fifth shift element or is connectable to the sun gear of the fourth planetary gear set.

This configuration permits four reverse gears, which may have a higher gear increment in comparison with the forward gears. In this configuration, the reverse gears are all implemented by means of the same friction clutch or the same subtransmission, respectively, and therefore are not power shiftable. However, a shifting under load between a reverse gear and a forward gear is possible by a shifting of the load-bearing friction clutch.

In another embodiment of the invention, it is possible to provide that, for implementation of up to four reverse gears, a fourth planetary gear set, which is active as a reversing gear set, and a fifth shift element, which has two shift positions, are situated axially between the first planetary gear set and the second planetary gear set and upstream from the second planetary gear set with regard to the drive technology, wherein with the fourth planetary gear set, the ring gear can be connected alternately to the ring gear or the planet carrier of the second planetary gear set by means of the second shift element; the sun gear of the fourth planetary gear set is connected to the second transmission input shaft, and the planet carrier is alternately lockable on a rotationally fixed component by means of the fifth shift element or is connectable to the sun gear of the fourth planetary gear set.

According to another variant of the invention, it is provided that, for implantation of one or two reverse gears, a fourth planetary gear set, which is active as a reversing gear set, and a fifth shift element, which has one shift position, are situated axially between the second planetary gear set and the third planetary gear set and downstream from the second planetary gear set with regard to the drive technology; the fifth shift element and the second shift element are combined into a single shift element with three shift positions; in the fourth planetary gear set, the ring gear is connected to the planet gear of the second planetary gear set; the sun gear can be connected to the second transmission input shaft by means of the fifth shift element; and in which the planet carrier together with the sun gear of the second planetary gear set is or can be locked on a rotationally fixed component.

This transmission configuration permits only two reverse gears but it allows elimination of a separate fifth shift element, because the function for changing from the forward gears to the reverse gears can be integrated into the existing second shift element as a third shift position, thereby reducing the cost and construction space. Furthermore, with this configuration, the first and second shift elements may also be combined into a single shift element with three shift positions.

The transmission structure according to the invention, with two subtransmissions or with two power paths, respectively, by way of two transmission input shafts also permits a simple implementation in a hybrid drive train.

In another preferred embodiment of the invention, the vehicle transmission may accordingly be designed as a so-called hybrid transmission, in which it is provided that the second transmission input shaft is drive-connected to the rotor of an electric machine; a first decoupling element and a second decoupling element are situated therein, wherein the first decoupling element is designed as a friction clutch, by means of which the drive shaft can be connected to the planet carrier of the first planetary gear set, which is active as its drive element, and in which the second decoupling element is designed as a form-locking clutch, by means of which the planet carrier of the first planetary gear set can be connected to the second transmission input shaft on the transmission end.

The second transmission input shaft may thus be drive-connected to the rotor of an electric machine. Then, with the second subtransmission, driving strictly with an electric motor drive is possible due to the electric machine. The first subtransmission can be operated by means of an internal combustion engine. Instead of a friction clutch, a form-locking clutch, by means of which the electric machine can he connected to the planet carrier, i.e., to the drive element of the first planetary gear set, may be situated on the second transmission input shaft. This permits combined operation based on a drive by an electric motor and by an internal combustion engine. Due to the shiftable connection between the electric machine and the internal combustion engine, the known hybrid functions are also possible, such as battery charging, boosting and starting the internal combustion engine by means of the electric machine. In this embodiment, a friction clutch is situated on the transmission input to enable complete decoupling of the planet carrier of the first planetary gear set and thus the transmission from the internal combustion engine, or to activate the internal combustion engine, respectively, as needed.

One possible shift pattern for this hybrid transmission, with a power shiftable gear sequence, may correspond to a shift pattern of a transmission according to the embodiments with two friction clutches or with one friction clutch and one brake.

Due to the possibility of reversing the direction of rotation of the electric motor drive, reverse gears can be implemented with the hybrid drive train without the additional use of a reversing gear set, such that the transmission ratio of the lowest forward gear in particular can be used for reverse driving operation with the electric motor.

In another embodiment of the vehicle transmission for a hybrid drive train, it is provided that the vehicle transmission is designed as a so-called hybrid transmission, with which the second transmission input shaft is operatively connected to the rotor of the electric machine, in which a decoupling element, designed as a form-locking clutch, is situated, by means of which the planet carrier of the first planetary gear set can be connected to the second transmission input shaft on the transmission end, and in which the drive shaft is connected to the planet carrier of the first planetary gear set, which is active as its drive element.

It is thus also possible in the hybrid embodiment of a vehicle transmission according to the invention to completely omit a friction clutch on the input end and to provide only a form-locking clutch for a shiftable connection of the electric machine to the drive shaft by means of the first planetary gear set. Start-up operation of the vehicle then takes place exclusively by means of the electric machine.

In addition, it is possible to provide that the decoupling element, which is designed as a form-locking clutch, and the fourth shift element are combined as a single shift element with two shift positions, with which the planet gear of the first planetary gear set can alternately be connected to the second transmission input shaft on the transmission end or the first transmission input shaft may be connected to the second transmission input shaft. This achieves the result that, in the case of the hybrid transmission, all the shift elements are designed as bidirectional shift packages, so that additional cost advantages and construction space advantages are obtained.

The embodiments of the vehicle transmission according to the invention described so far permit eight power shiftable forward gears, including one direct gear and one overdrive gear, with three planetary gear sets, or seven power shiftable forward gears without an overdrive gear. With an additional reversing gear set, up to eight reversing gears are possible. When using an electric machine that can be operated as a generator and as an electric motor, it is possible as an alternative to implement an electric motor-driven reversing function without an additional reversing gear set.

In addition, the vehicle transmission can also be designed, by an expansion, with a splitter group and/or a range group to form a group transmission, so that the number of gears of a main transmission can be doubled in the design of the embodiments described previously. This can be advisable in particular for applications in commercial vehicles.

According to another preferred embodiment of the invention, it may therefore be provided that the vehicle transmission is designed as a double clutch group transmission, in which the first, second and third planetary gear sets can be shifted by means of at least one first, second and third shift element, each having two shift positions;

a range group is situated downstream from the third planetary gear set with regard to the drive technology;

the range group having a fourth planetary gear set, which is designed as a reversing gear set, to which a fifth shift element with one shift position is assigned for shifting a reverse gear group, and having a fifth planetary gear set to which a sixth shift element, having two shift positions for shifting between a slow and a fast forward gear group, is assigned;

with the fourth planetary gear set, the ring gear is connected to the sun gear of the fifth planetary gear set, the sun gear is connected to the planet carrier of the third planetary gear set, and the planet carrier is connected to the ring gear of the fifth planetary gear set and can be locked by means of the fifth shift element on a rotationally fixed component;

with the fifth planetary gear set, the sun gear can alternately be locked on a rotationally fixed component by means of the sixth shift element or be connected to the planet carder, and the planet carrier is connected to the output shaft;

if is possible to shift to at least fourteen forward gears and at least seven reverse gears by means of five shift elements with a total of nine shift positions;

of the at least fourteen forward gears, at least thirteen are power shiftable and the fourteenth forward gear is a direct gear, and the at least seven reverse gears are all power shiftable.

Thus, due to this transmission configuration, the number of gears of a seven-gear main transmission having the features of the present invention can be doubled by means of a range group. Changing gears with the range group is thus possible without a an interruption in tractive force even without additional measures. However, the interruption in tractive force can be minimized by the design of a lower gear increment in comparison with the other gears in the case of range shifting and thus there is less loss of speed. All other gears, including the seven reverse gears, are power shiftable. In particular low gears, such as those which are usually required for applications in commercial vehicles, can be made available due to the downstream transmission ratio of the fifth planetary gear set. The transmission ratios of the reverse gears can be comparable to the transmission ratios of the corresponding forward gears.

According to another preferred embodiment of the invention, it is possible to provide that the vehicle transmission is designed as a double clutch group transmission, with which the first, second and third planetary gear sets are shiftable by means of a first, second and third shift element, each having two shift positions;

a fourth planetary gear set, which is active as a range group, and a sixth shift element, which has two shift positions for changing gears between a slow forward gear group and a fast forward gear group, are situated downstream from the third planetary gear set with regard to the drive technology;

with the fourth planetary gear set, the ring gear can be alternately locked on a rotationally fixed component or connected to the planet carrier, the sun gear is connected to the planet carrier of the third planetary gear set, and the planet carrier is connected to the output shaft;

a fifth planetary gear set, which is active as a reversing gear set, and a fifth shift element, which has two shift positions, are situated upstream from the first planetary gear set with regard to the drive technology;

with the fifth planetary gear set, the ring gear is connected to the planet carrier of the first planetary gear set, the sun gear is connected to the drive shaft, and the planet carrier can alternately be locked on a rotationally fixed component or connected to the sun gear by means of the fifth shift element;

it is possible to shift to at least fourteen forward gears and at least seven reverse gears by means of five shift elements with a total of ten shift positions;

of the at least fourteen forward gears, at least thirteen are power shiftable, and the fourteenth forward gear is a direct gear, and the at least seven reverse gears are all power shiftable.

This last configuration thus has a fourth planetary gear set, which is downstream from the main gear as a range group with regard to the drive technology as well as having a fifth planetary gear set, which is upstream from the main gear as a reversing gear set. A lower gear group and an upper gear group, each having seven gears, can be implemented in one possible shift pattern, wherein the change in range involves an interruption in tractive force. The gear increment of the range change is expediently designed to be relatively small. The range change may thus take place with minimized rotational speed adaptation of the internal combustion engine, which facilitates a particularly short shift time. The reverse gears may have a comparatively low transmission ratio and may have, for example, a transmission ratio that is 1.8 times that of the corresponding forward gears, which is advantageous for maneuvering. To limit the load on the transmission, a torque limitation is advantageous for the internal combustion engine in reverse driving operation.

### BRIEF DESCRIPTION OF THE DRAWINGS

To further illustrate the invention, the description includes drawings of a plurality of exemplary embodiments, in which:

FIG. 1 shows a transmission pattern of a first embodiment of a vehicle transmission according to the invention, having two clutches on the input end and three planetary gear sets with a shiftable direct connection between a first transmission input shaft and an output shaft,

FIG. 2 shows a transmission pattern of planetary gear sets for a vehicle transmission according to FIG. 1,

FIG. 3 shows a shift pattern for the 8-gear vehicle transmission according to FIG. 1, having one direct gear and one overdrive gear,

FIG. 4 shows a transmission pattern of a second embodiment of a vehicle transmission according to the invention, with a shiftable subtransmission coupling by means of a transmission input shaft connection,

FIG. 5 shows a shift pattern for the 8-gear vehicle transmission according to FIG. 4, with one direct gear and one overdrive gear,

FIG. 6 shows a transmission pattern of a third embodiment of a vehicle transmission, with a triple shift element,

FIG. 7 shows a transmission pattern of a fourth embodiment of a vehicle transmission, with only double shift elements,

FIG. 8 shows a shift pattern for the 7-gear vehicle transmission according to FIG. 7, with one direct gear,

FIG. 9 shows a transmission pattern of a fifth embodiment of a vehicle transmission, with radially nested planetary gear sets,

FIG. 10 shows a transmission pattern of a sixth embodiment of a vehicle transmission with a clutch on the input end and a brake on the input end,

FIG. 11 shows a shift pattern for the 8-gear vehicle transmission according to FIG. 10, with one direct gear and one overdrive gear,

FIG. 12 shows a transmission pattern of a seventh embodiment of a vehicle transmission, with a first hybrid drive assembly,

FIG. 13 shows a shift pattern for the 8-gear vehicle transmission according to FIG. 12, with one direct gear and one overdrive gear,

FIG. 14 shows a transmission pattern of an eighth embodiment of a vehicle transmission, with a second hybrid drive configuration,

FIG. 15 shows a shift pattern for the 8-gear vehicle transmission according to FIG. 14, with one direct gear and one overdrive gear,

FIG. 16 shows a transmission pattern of a ninth embodiment of a vehicle transmission, with one first configuration of a reverse gear planetary gear set,

FIG. 17 shows a transmission ratio pattern of planetary gear sets for a vehicle transmission according to FIG. 16,

FIG. 18 shows a shift pattern for the 8-gear vehicle transmission according to FIG. 16, with one direct gear and one overdrive gear and with eight reverse gears,

FIG. 19 shows a transmission pattern of a tenth embodiment of a vehicle transmission, with a second configuration of a reverse gear planetary gear set,

FIG. 20 shows a shift pattern for the 8-gear vehicle transmission according to FIG. 19, with one direct gear and one overdrive gear plus four reverse gears,

FIG. 21 shows a transmission pattern of an eleventh embodiment of a vehicle transmission, with a third configuration of a reverse gear planetary gear set,

FIG. 22 shows a transmission ratio pattern of planetary gear sets for a vehicle transmission according to FIG. 21,

FIG. 23 shows a shift pattern for the 8-gear vehicle transmission according to FIG. 21, with one direct gear and one overdrive gear plus two reverse gears,

FIG. 24 shows a transmission pattern of a twelfth embodiment of a vehicle transmission, with one additional shift element,

FIG. 25 shows a shift pattern for the 8-gear vehicle transmission according to FIG. 24, with one direct gear and one overdrive gear,

FIG. 26 shows a transmission pattern of a fourteen-gear embodiment of a vehicle transmission, with one range group with an integrated reverse gear planetary gear set,

FIG. 27 shows a transmission pattern with stationary transmission ratios of planetary gear sets for a vehicle transmission according to FIG. 26,

FIG. 28 shows a shift pattern for the 14-gear vehicle transmission according to FIG. 26, with one direct gear and with seven reverse gears,

FIG. 29 shows a transmission pattern of a fourteenth embodiment of a vehicle transmission, with one range group and with one reverse gear planetary gear set as a splitter group,

FIG. 30 shows a transmission pattern with stationary transmission ratios of planetary gear sets for a vehicle transmission according to FIG. 29, and

FIG. 31 shows a shift pattern for the 14-gear vehicle transmission according to FIG. 29, with one direct gear and with seven reverse gears.

### DETAILED DESCRIPTION OF THE PREFERRED EMBODIMENTS

It should be pointed out by way of introduction that, for the sake of simplicity, all components having the same design or function are provided with the same reference symbols.

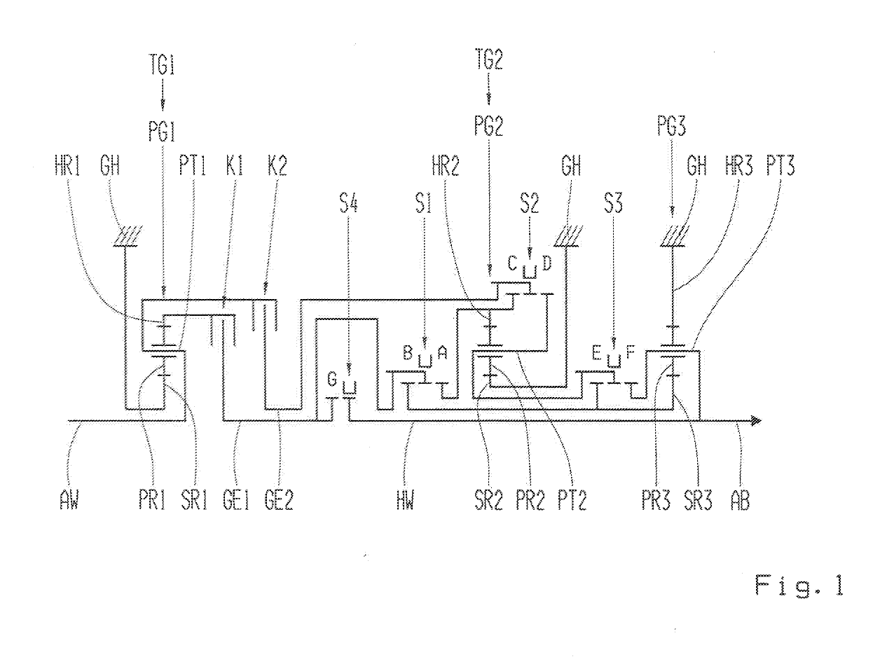

The vehicle transmission depicted schematically in FIG. 1 thus has essentially three planetary gear sets PG1, PG2, PG3, one drive shaft AW, two transmission input shafts GE1, GE2, two decoupling elements K1, K2, designed as friction locking clutches, one main shaft HW and one output shaft AB, which are situated in a mutually coaxial configuration.

The three planetary gear sets PG1, PG2, PG3 are designed as simple minus transmissions, each comprising one radially exterior ring gear HR1, HR2, HR3, one internal sun gear SR1, SR2, SR3 and one planet carrier PT1, PT2, PT3, wherein each planet carrier PT1, PT2, PT3 has a plurality of planet gears PR1, PR2, PR3, which mesh with the sun gear SR1, SR2, SR3 and the ring gear HR1, HR2, HR3.

The first planetary gear set PG1 is situated on the transmission input. Its planet carrier PT1 is connected to the drive shaft AW at the input end in a rotationally fixed manner, this drive shaft being drive-connected to a drive machine (not shown), which is designed as an internal combustion engine, for example. The planet carrier PT1 is thus active as a drive element of the first planetary gear set PG1. The planet carrier PT1 of the first planetary gear set PG1 is connected at the transmission end to the second friction clutch K2. The second friction clutch K2 is drive-connected at the output end, or at the transmission end, respectively, to the second input transmission shaft GE2, which is designed as a hollow shaft. The sun gear SR1 of the first planetary gear set PG1 is locked on a rotationally fixed component GH, for example, a transmission casing. The ring gear HR1 of first planetary gear set PG1 is drive-connected to the first friction clutch K1 and is thus active as an output drive element of the first planetary gear set PG1. The first friction clutch K1 is drive-connected at the transmission end to the first transmission input shaft GE1, which is designed as a radially inner shaft with respect to the second transmission input shaft GE2, coming out of the radially outer second transmission input shaft GE2 at the transmission end. The first planetary gear set PG1 together with the first friction clutch K1 and the first transmission input shaft GE1 forms a first subtransmission TG1 with a first fixed input transmission ratio. To establish a driving connection between the drive shaft AW and the second friction clutch K2, the first planetary gear set PG1 is merely bypassed, via the planet carrier PT1.

The second planetary gear set PG2, which follows in the axial direction and, together with the second friction clutch K2 and the second transmission input shaft GE2, forms a second subtransmission TG2 with a second fixed input transmission ratio with regard to the drive technology, wherein its ring gear HR2 is active as a drive element and its planet carrier PT2 is active as an output drive element. The sun gear SR2 of the second planetary gear set PG2 is in turn locked on the rotationally fixed component GH.

The main shaft HW is situated coaxially, and axially adjacent to the two transmission input shafts GE1, GE2. The end of the main shaft HW on the output end passes axially through the third planetary gear set PG3 and is connected to the output drive shaft AB in a rotationally fixed manner.

The three planetary gear sets PG1, PG2, PG3 are each shiftable by means of a first, a second and a third shift element S1, S2, S3, each having two shift positions A/B, C/D, E/F, to which it is possible to shift in alternation, and they can be shifted by means of a fourth shift element S4 having only one shift position G.

The first transmission input shaft GE1 or the first friction clutch K1 respectively, is connectable by means of the first shift element S1 in its first shift position A to the hollow shaft HR2 of the second planetary gear set PG2. The first transmission input shaft GE1 or the second friction clutch K2, respectively, can be connected to the sun gear SR3 of the third planetary gear set PG3 by means of the second shift position B of the first shift element S1. In addition, with the second planetary gear set PG2, the planet carrier PT2 can be connected by means of the third shift element S3 in its second shift position F to the planet carrier PT3 of the third planetary gear set PG3. Furthermore, the first transmission input shaft GE1 can be connected directly to the main shaft HW and thus to the drive shaft AB by means of the fourth shift element S4 in its shift position G.

The second transmission input shaft GE2 or the second friction clutch K2, respectively, can be connected alternately to the ring gear HR2 by means of the second shift element S2 in its first shift position C or to the planet carrier PT2 of the second planetary gear set PG2 in its second shift position D.

With the third planetary gear set PG3, the hollow shaft HR3 is locked on the rotationally fixed component GH, the sun gear SR3 can be connected to the planet carrier PT2 of the second planetary gear set PG2 by means of the third shift element S3 in its first shift position E, and the planet carrier PT3 is fixedly connected at the output end to the output drive shaft AB.

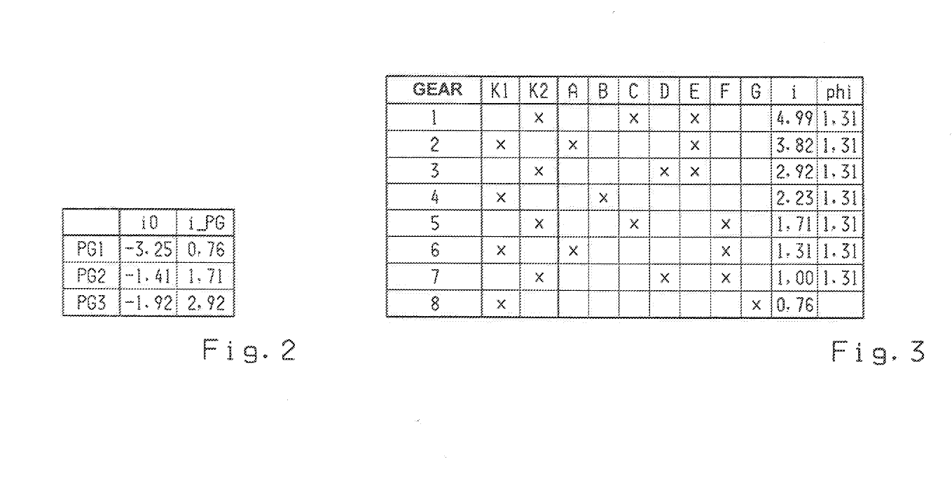

FIG. 2 shows, as a numerical example, one possible transmission ratio of the three planetary gear sets PG1, PG2, PG3 embodied as minus gears, such that, in addition to the respective minus stationary transmission ratio i_0, with the planet carrier stationary, the plus planetary gear set transmission ratio i_PG is also given in the transmission structure according to FIG. 1. It can be seen from this that the drive elements and output elements have the same direction of rotation.

FIG. 3 shows one possible shift pattern of the transmission configuration according to FIG. 1. The shift positions of the transmission, which are activated to set the respective gear, are labeled with the lower-case letter “x” in the shift pattern. Thus, with the transmission according to FIG. 1, it is possible to shift to eight forward gears “1” through “8.” The gears are activated by engaging the two clutches K1, K2 in sequential gear changes in the shift sequence, such that by overlapping engagement and disengagement of the clutches K1, K2 the power transfer between the two subtransmissions TG1, TG2 is maintained without an interruption in tractive force. The functioning of the transmission according to FIG. 1 is thus that of a double clutch transmission.

For example, the gear change between the first gear “1” and the second gear “2” takes place as follows:

The second clutch K2 is engaged in first gear “1.” The second subtransmission TG1 thus carries the load. The second shift element S2 is in shift position C here, in which the ring gear HR2 of the second planetary gear set PG2 is connected to the second transmission input shaft GE2 at the drive end, and, by means of the second friction clutch K2 and the planet carrier PT1 of the first planetary gear set PG1, is connected to the drive shaft AW. The third shift element S3 is in its first shift position E, in which the planet carrier PT2 of the second planetary gear set PG2 acts as an output drive element and is connected to the sun gear SR3 of the third planetary gear set PG3, so that the transmission ratio of the third planetary gear set PG3 also acts on the output drive shaft AB. According to the example of FIGS. 2 and 3, this yields a transmission ratio of i=4.99 for the first gear “1.”

In the second gear “2,” the shift position E of the third shift element S3 is maintained. In addition, the first shift element S1 is moved into its first shift position A, in which the ring gear HR2 of the second planetary gear set PG2 is connected to the first transmission input shaft GE1. This is possible because, when shifting to the first gear “1,” the first clutch K1 is still disengaged and thus the first subtransmission TG1 is still inactive.

To perform the gear change from first gear “1” to second gear “2,” the second clutch K2 is then disengaged and the first clutch K1 is engaged, such that the friction locking effect with the second clutch K2 is dissipated and is built up with the first clutch K1. Therefore, the power transfer from the second subtransmission TG2 to the first subtransmission TG1 takes place without a loss of tractive force in the drive train. Next, the second shift element S2 can be disengaged in a no-load operation to move its shift position C, which was previously shifted to the first gear “1.”

In the shift pattern of FIG. 3, the transmission ratio i is given for each of the eight gears “1” to “8.” The gears “1” to “8” have a constant gear increment phi=1.31, i.e., a geometric staging. The seventh gear “7” is designed as a direct gear. In this gear “7” with the second clutch K2 engaged, the drive shaft AW is drive connected to the output drive shaft AB by means of the three planet carriers PT1, PT2, PT3 of the three planetary gear sets PG1, PG2, PG3.

The eighth gear “8” which can be activated by engaging the fourth shift element S4 is designed as an overdrive gear and/or as a high speed gear. In the respective shift position G of the fourth shift element S4 and with the first clutch K1 engaged, the transmission ratio of the first planetary gear set PG1 is active directly on the output drive.

The transmission structure according to FIG. 1 does not include a reverse gear, in order to illustrate the basic design of the transmission. The transmission structure therefore forms a basic gear set, which can be expanded by a reversing gear set to implement at least one reverse gear.

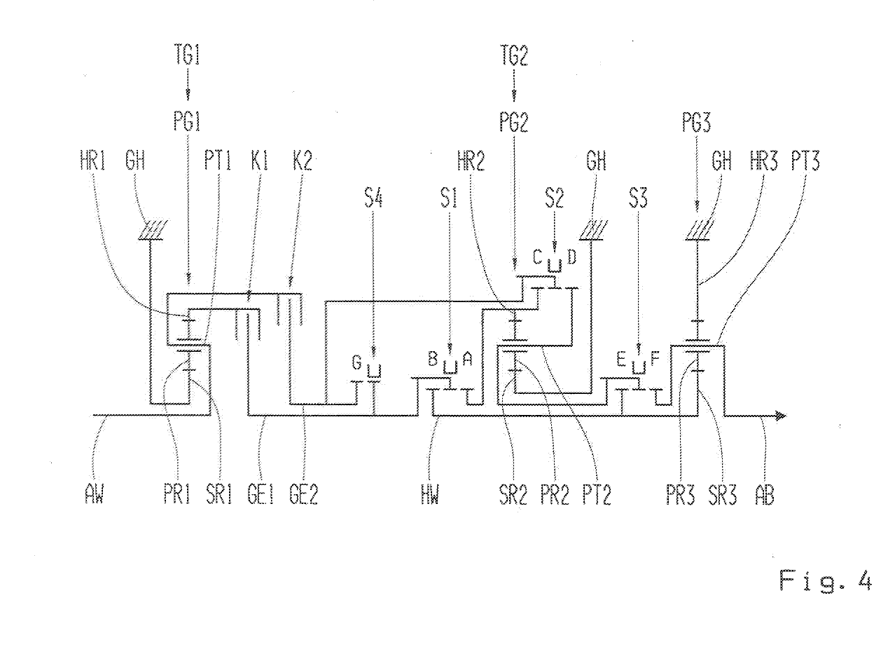

FIG. 4 shows a basic gear set modified with respect to FIG. 1, in which the output end of the main shaft HW is not connected directly to the output shaft AB but instead is connected to the sun gear SR3 of the third planetary gear set PG3. Furthermore, a direct connection cannot be established between the first transmission input shaft GE1 and the main shaft HW by means of the fourth shift element S4, but instead a connection can be established between the first transmission input shaft GE1 and the second transmission input shaft GE2, so that a coupling of the two subtransmissions TG1, TG2 can be implemented. This eliminates one shaft plane between the main shaft plane HW and the plane of the planet carrier shaft PT2 of the second planetary gear set PG2. Otherwise this transmission structure corresponds to the transmission structure according to FIG. 1.

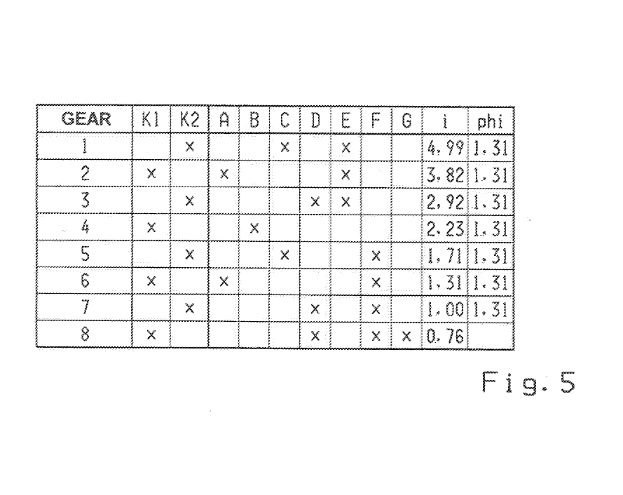

FIG. 5 shows a corresponding shift pattern. The eighth gear “8” is designed as an overdrive gear, and this transmission structure is implemented by a coupling of the two subtransmissions TG1, TG2 by means of the fourth shift element S4 as well as by shifting of the planet carriers PT2, PT3 of the second and third planetary gear sets PG2, PG3 on the output shaft AB. To this end, the second and third shift elements S2, S4 are shifted into their shift positions D and F, respectively. In shifting from the seventh gear “7,” which is embodied as a direct gear, to the overdrive gear (eighth gear “8”), the shift positions D and F, respectively, of the second and third shift elements S2, S4 remain within the range of the second and third planetary gear sets PG2, PG3. Otherwise the shift pattern of FIG. 5 corresponds to the shift pattern of FIG. 3 of the basic gear set according to FIG. 1.

The transmission structure according to FIG. 4 can be expanded by a reversing gear to implement reverse gears. Different reverse gear variants will be explained later.

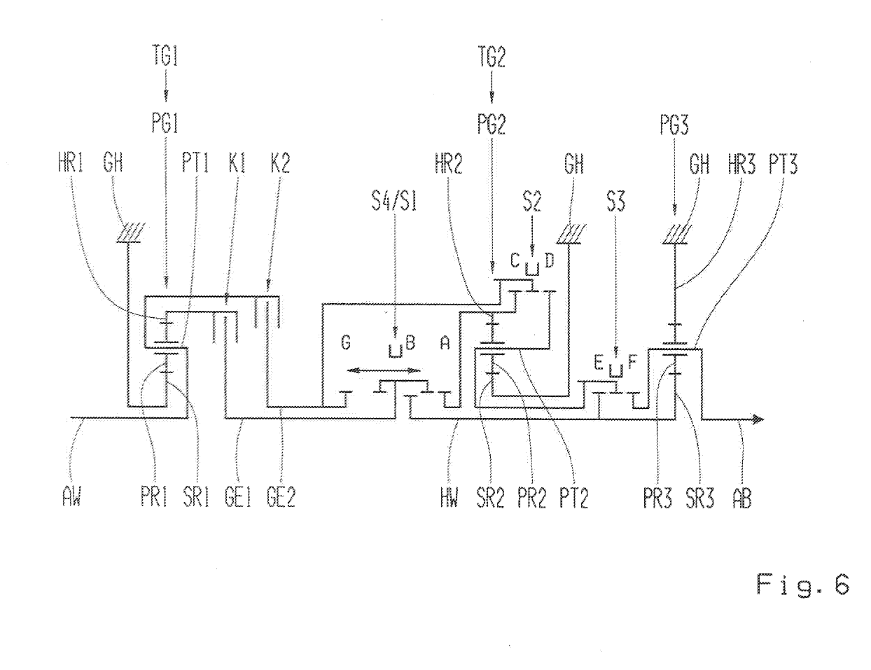

FIG. 6 shows a configuration that has mostly the same design as the transmission structure according to FIG. 4, but in which the first and the fourth shift elements S1, S4 are combined into a triple shift element S4/S1 with a total of three shift positions A, B, G. The three shift positions A, B, G can be activated sequentially and alternately with a common actuator. As shown by the shift pattern according to FIG. 5, these shift positions A, B, G are never engaged at the same time because they are assigned to the same subtransmission TG1. Therefore, this triple shift element S1, S4 can be utilized with its three shift positions A, B, G.

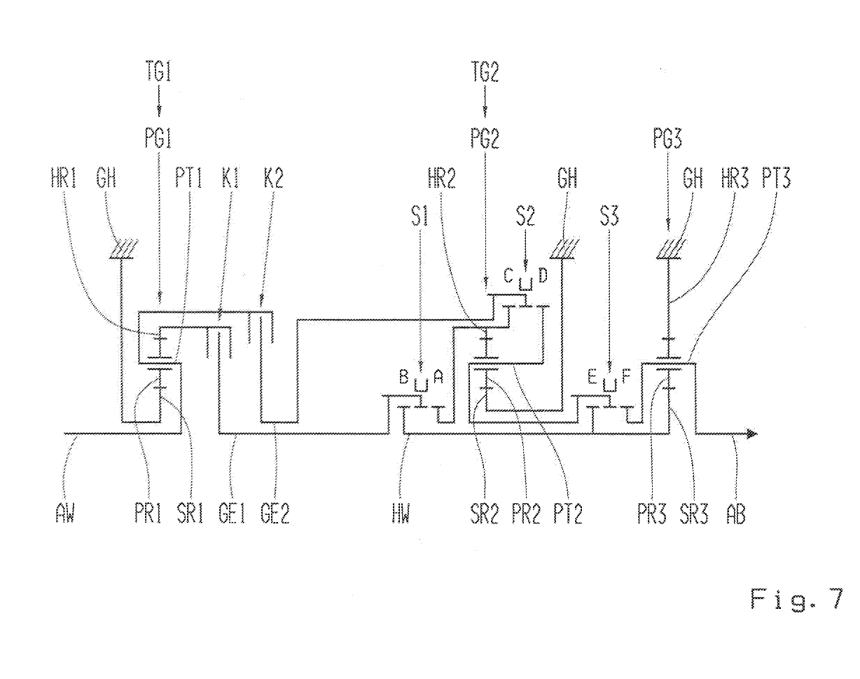

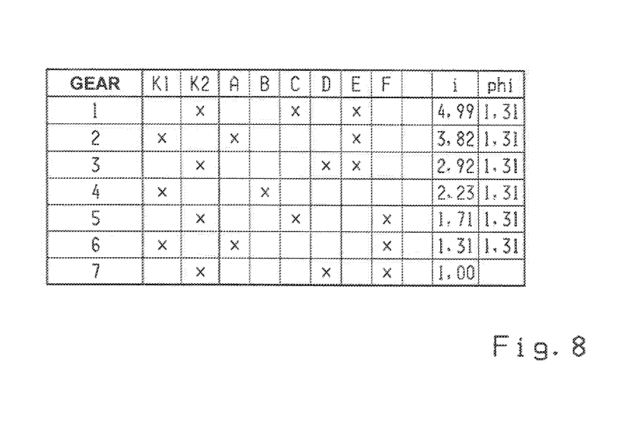

FIG. 7 shows another variant of the basic gear set according to FIG. 4, but the fourth shift element S4 has been omitted here. This forms a transmission structure having only the first, second and third double shift elements S1, S2, S3. Since the fourth shift element S4, which has been omitted, was needed for the overdrive gear “8,” only one shift pattern, having seven gears “1” to “7,” can be implemented with the transmission configuration according to FIG. 7. This shift pattern is shown in FIG. 8. Except for the overdrive gear that was omitted, it corresponds to the shift pattern according to FIG. 5 of the transmission according to FIG. 4.

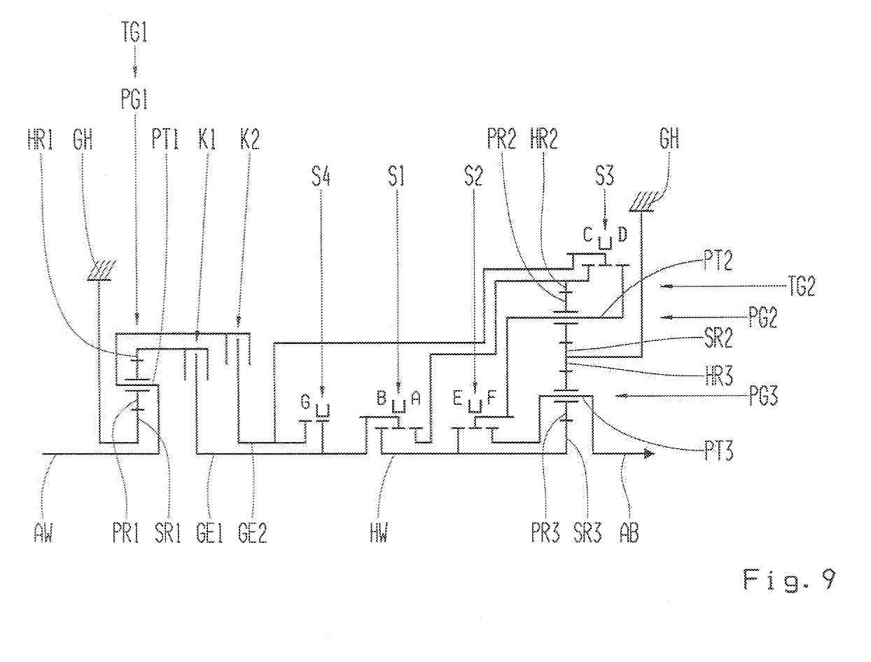

FIG. 9 shows another variant of the basic gear set according to FIG. 4, but the second and third planetary gear sets PG2, PG3 here are situated coaxially and radially one above the other in a common gear plane. The ring gear HR3 of the third planetary gear set PG3 has a rotationally fixed connection to the sun gear SR2 of the second planetary gear set PG2. Otherwise, the linking of the individual gear set elements, as well as the shift pattern, corresponds to the transmission structure according to FIG. 4 or the shift pattern according to FIG. 5, respectively.

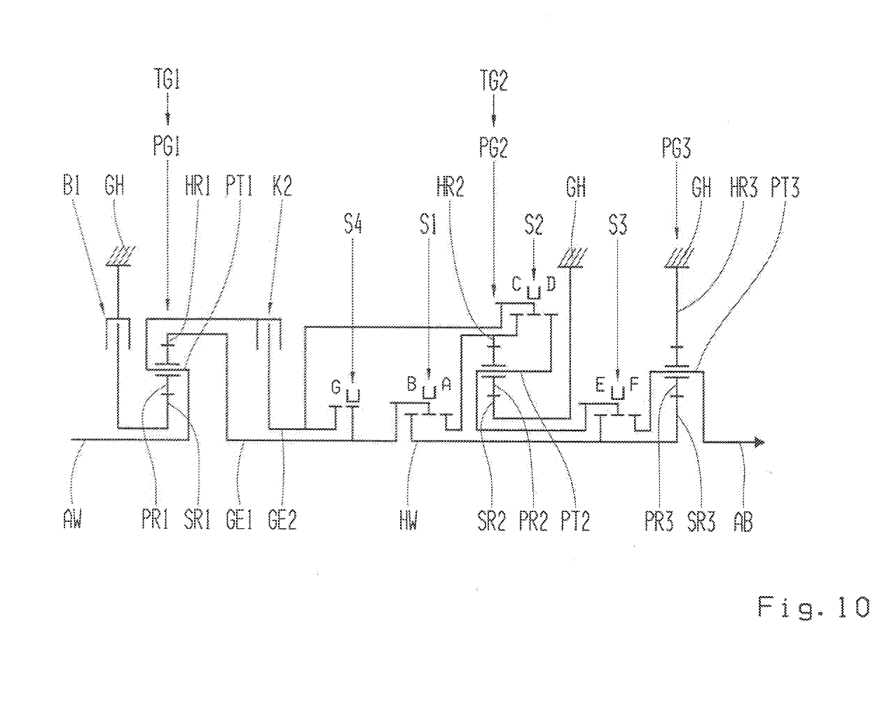

FIG. 10 shows a transmission structure in which a brake 81 is situated instead of the first friction clutch K1 This is possible because the first planetary gear set PG1 is active as an input constant of the first subtransmission TG1. The sun gear SR1 of the first planetary gear set PG1 can be locked onto and released from the stationary component GH by means of the brake B1. However, the first transmission input shaft GE2 is connected to the ring gear HR1 of the first planetary gear set PG1 in a rotationally fixed manner.

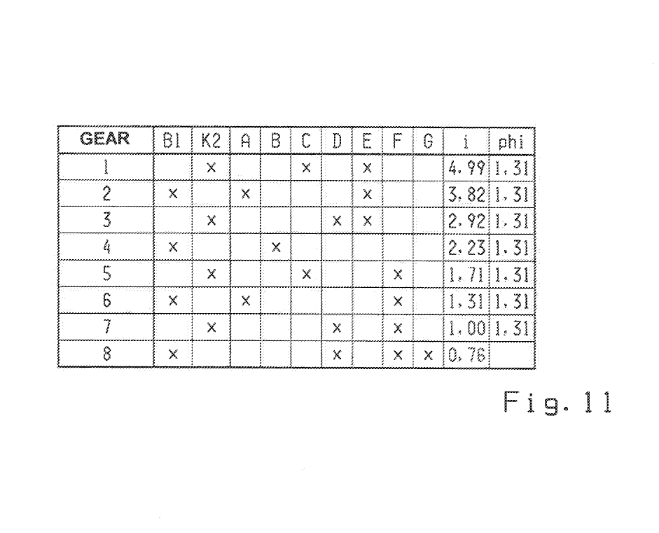

A shift pattern for a transmission structure according to FIG. 10, as shown in FIG. 11, corresponds largely to the shift pattern of FIG. 5, wherein the brake B1 is actuated instead of the first clutch K1. The transmission ratios of the eight forward “1” through “8” and the stationary transmission ratios i_0 as well as the active transmission ratios i_PG of the planetary gear sets PG1, PG2, PG3 are identical to those of the transmission according to FIG. 4.

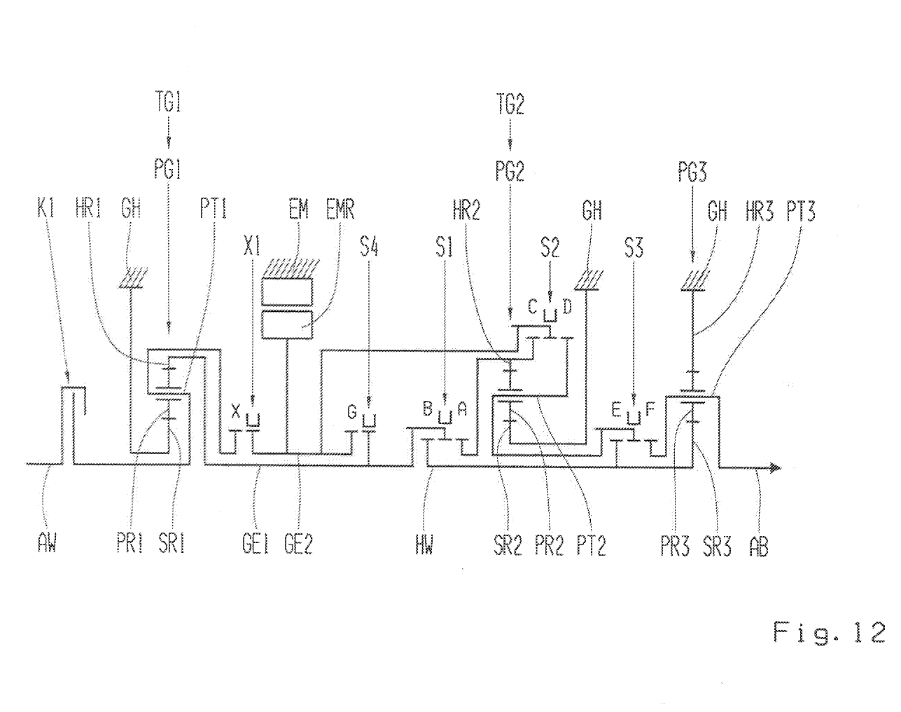

FIG. 12 shows an embodiment which is identified as a hybrid transmission because this transmission can be used advantageously in the drive train of a hybrid vehicle with an internal combustion engine and with an electric motor drive. With this configuration, instead of second decoupling element, or a second friction clutch K2, the rotor EMR of an electric machine EM is connected to the second transmission input shaft GE2. In addition, there is a form-locking decoupling clutch X1, by means of which the second transmission input shaft GE2 can be connected to the planet carrier PT1 of the first planetary gear set PG1 in its engaged shift position X. The first decoupling element K1 is embodied as a decoupling clutch on the transmission input end, by means of which the planet carrier PT1 of the first planetary gear set PG1 can be connected to the drive shaft AW at the drive end and/or can be released therefrom. Therefore, combined driving operation with an internal combustion engine and an electric motor as well as decoupling of the internal combustion engine from the drive train are possible. The transmission structure otherwise corresponds to that according to FIG. 4.

FIG. 13 shows a respective possible shift pattern. It can be seen from this that the drive is provided by the electric machine EM and by means of the internal combustion engine in the odd gears “1,” “3,” “5,” “7,” which are assigned to the second subtransmission TG2. The first friction clutch K1 may remain engaged in all gears. Fundamentally, however, strictly electric motor driving operation is also possible in the odd gears “1,” “3,” “5,” “7” with the friction clutch K1 disengaged. In the even gears “2,” “4,” “6,” “8,” which are assigned to the first subtransmission TG1 the drive is provided only by the internal combustion engine and, respectively, by means of the engaged friction clutch K1. In shifting from seventh gear “7” to eighth “8” gear, i.e., from the direct gear to the overdrive gear, the shift positions D, F of the second and third planetary gear sets PG2, PG3 remain the same. However, the overdrive gear “8” can only be driven by the internal combustion engine because the decoupling clutch X1 must be disengaged due to the subtransmission coupling in the overdrive gear “8.” When changing gears, power shifting can take place by way of the electric motor-driven gears as supporting gears.

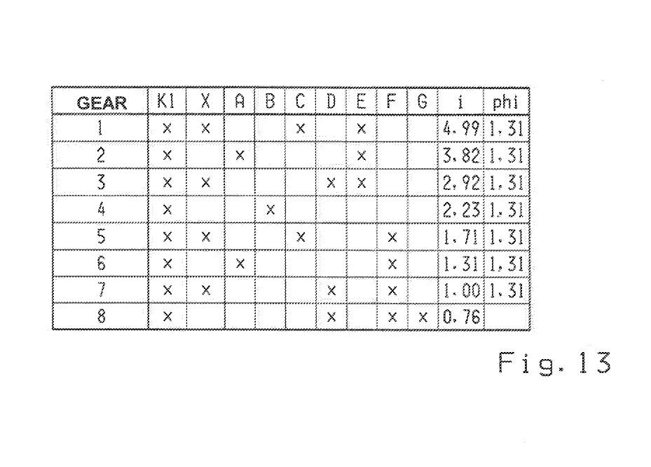

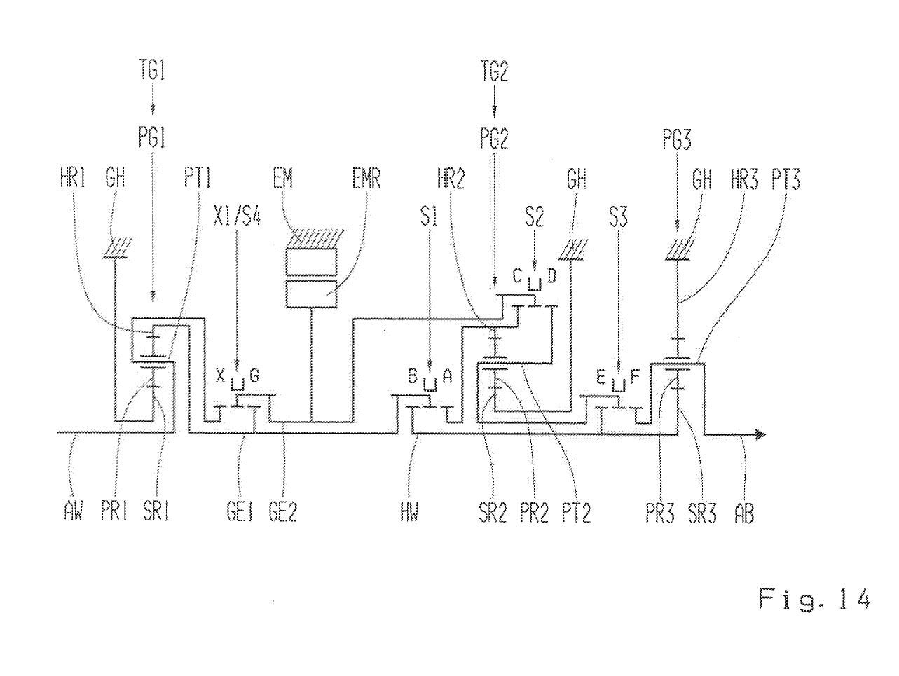

FIG. 14 shows a second embodiment of a hybrid transmission. With this transmission, in comparison with the transmission in FIG. 12, the first friction clutch K1 on the input end has been omitted, and the fourth shift element S4 and the form-locking decoupling clutch X1 are combined as a single bidirectionally activatable shift element X/S4. The hybrid transmission according to FIG. 14 thus does not require any friction clutches at all. The start-up processes with this transmission therefore take place only by electric motor with the help of an electric machine EM, whose rotor EMR is drive-connected to the second transmission input shaft GE2. Due to the fact that the fourth shift element S4 is combined with the form-locking decoupling clutch X1 to form a double shift element X1/S4, only double shift elements S1, S2, S3, X1/S4 are present in the transmission. This is also possible with the hybrid transmission according to FIG. 12.

FIG. 15 shows a respective shift pattern, from which it can be seen that the even gears “2,” “4,” “6,” “8” of the first subtransmission TG1 are shifted without a decoupling element on the input end.

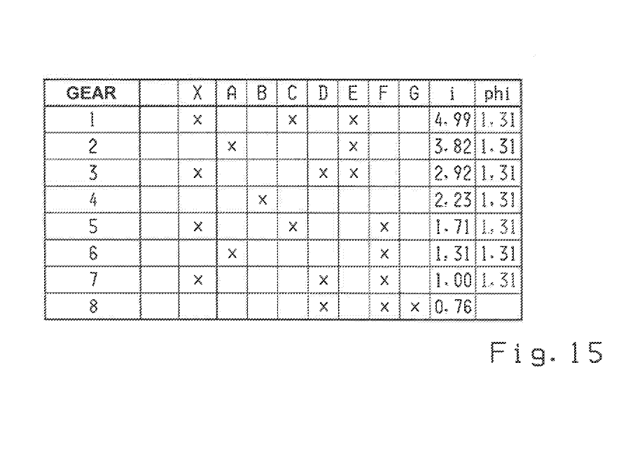

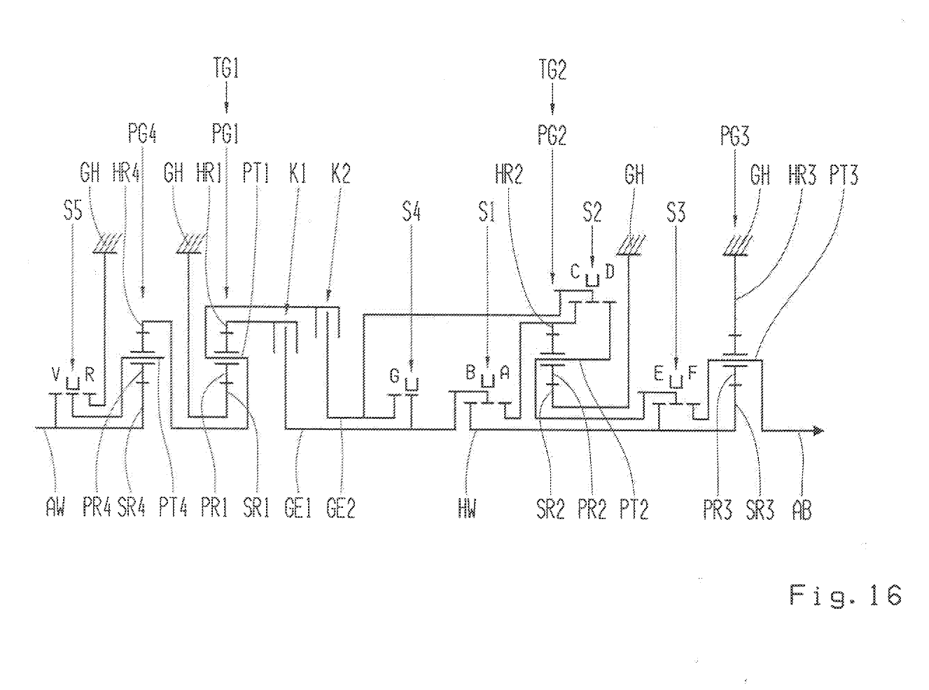

FIGS. 16 through 23 show various embodiments for installation of a reversing gear set in the transmission structure according to FIG. 4 for implementation of reverse gears.

Thus, according to FIG. 16, a fourth planetary gear set PG4, which is active as a reversing gear set, is situated according to FIG. 16. The fourth planetary gear set PG4 is situated upstream from the first planetary gear set PG1 both axially and with regard to the drive technology and is thus assigned to the first subtransmission TG1. Furthermore, a fifth shift element S5 is present with two shift positions V, R for switching between a forward driving operation and a reverse driving operation. The ring gear HR4 of the fourth planetary gear set PG4 is connected to the planet carrier PT1, i.e., to the drive element of the first planetary gear set PG1. The sun gear SR4 of the fourth planetary gear set PG4 is connected to the drive shaft AW. The planet carrier PT4 of the fourth planetary gear set PG4 can alternately be connected to the drive shaft AW by means of the fifth shift element S5 in its first shift position W or be locked on the rotationally fixed component GH in its second shift position R. Due to the connection of the planet carrier PT4 of the fourth planetary gear set PG4 to the drive shaft AW, it is simultaneously connected to the sun gear SR4 of the fourth planetary gear set PG4, so that, in forward driving operation, the reversing gear set PG4 has direct drive. By locking the planet carrier PT4 of the fourth planetary gear set PG4 on the rotationally fixed component GH, the minus stationary transmission ratio of the fourth planetary gear set PG4, which is embodied as a minus transmission, is active, so that, for a reverse driving operation, the direction of rotation between the driving sun gear SR4 and the ring gear HR4 on the output end of the fourth planetary gear set PG4 is reversed.

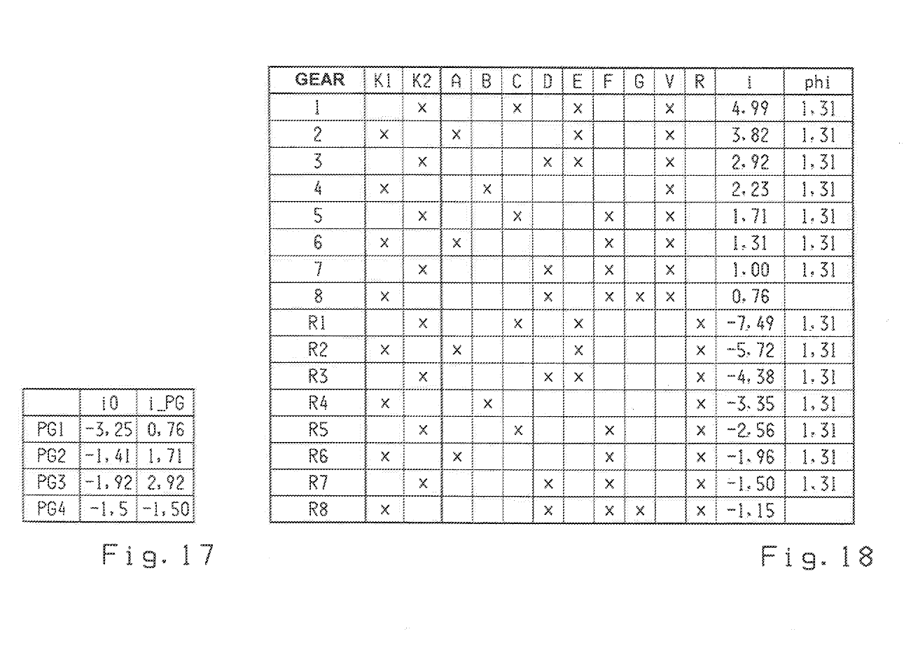

FIG. 17 shows, as a numerical example, a transmission ratio table containing the additional planetary gear set PG4, which shows that its active transmission ratio i_PG=−1.5 corresponds to the stationary transmission ratio i0=−1.5.

FIG. 18 shows one possible shift pattern of the transmission according to FIG. 12. For the eight forward gears “1” through “8,” the shift pattern corresponds to the shift pattern of FIG. 5 of the transmission structure according to FIG. 4, wherein the fifth shift element S5 is always in the forward gear shift position V. Furthermore, eight reverse gears R1, R2, R3, R4, R5, R5, R6, R7, R8 are implemented and are sequentially power shiftable, wherein the fifth shift element S5 is always in the reverse gearshift position R. The transmission ratio of the eight reverse gears R1 to R8 corresponds approximately to 1.5 times the eight forward gears “1” through “8.”

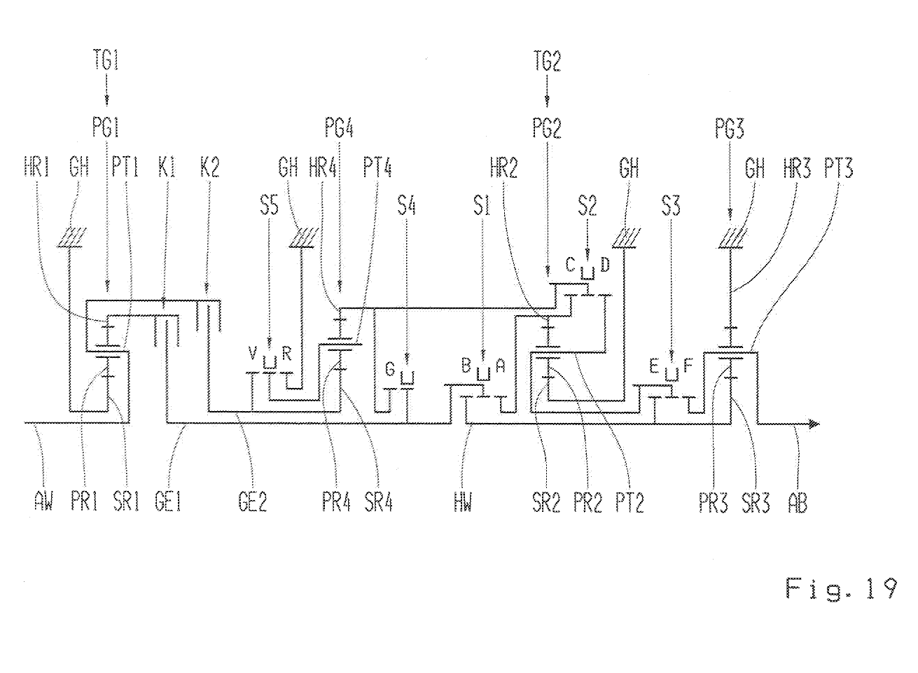

FIG. 19 shows a transmission structure with an alternative linking of a fourth planetary gear set PG4 between the first planetary gear set PG1 and the second planetary gear set PG2. The ring gear HR4 of the fourth planetary gear set PG4 can be connected by means of the second shift element S2 to the ring gear HR2 or to the planet carrier PT2 of the second planetary gear set PG2. The sun gear SR4 of the fourth planetary gear set PG4 is connected to the second transmission input shaft GE2. The planet carrier PT4 of the fourth planetary gear set PG4 can be connected alternately to the second transmission input shaft GE2 in its first shift position V by means of the fifth shift element S5 or, in its second shift position R, can be locked on the rotationally fixed component GH. By connecting the planet carrier PT4 of the fourth planetary gear set PG4 to the second transmission input shaft GE2, it is simultaneously connected to the sun gear SR4 of the fourth planetary gear set PG4, so that in forward driving operation, the sun gear of the fourth planetary gear set PG4 has direct drive.

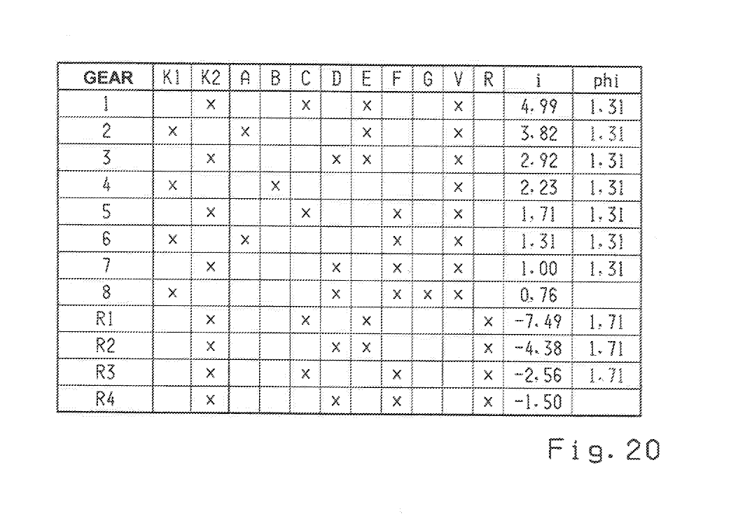

FIG. 20 shows one possible shift pattern of the transmission according to FIG. 19. Thus, with this transmission, four reverse gears R1 through R4 that are not power shiftable are implemented, the second decoupling element K2 of each being engaged and the first decoupling element K1 being disengaged. Their transmission ratios correspond to approximately 1.5 times the corresponding forward gears.

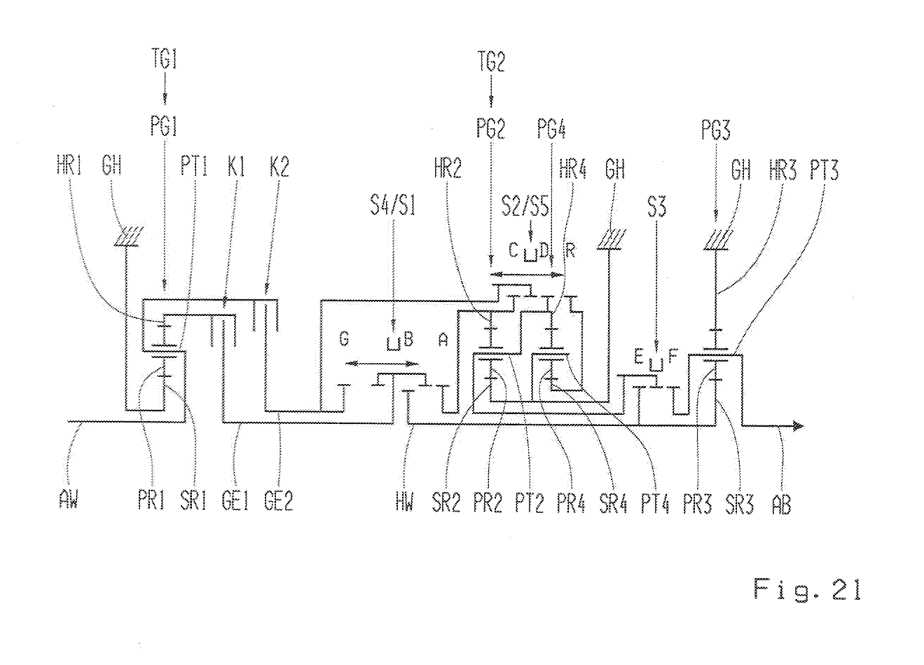

FIG. 21 shows another configuration of a fourth planetary gear set PG4, which is active as a reversing gear set for the transmission. With this transmission structure, the fourth planetary gear set PG4 is situated axially between the second planetary gear set PG2 and the third planetary gear set PG3. The fifth shift element S5 here requires only one shift position R for activation of the reverse driving function and is combined with the second shift element S2 to form a triple shift element S2/S5 with three shift positions C, D, R. In addition, the first shift element S1 and the fourth shift element S4 are combined into another triple shift element S4/S1 with three shift positions G, B, A. The planet carrier PT4 of the fourth planetary gear set PG4 is locked on the rotationally fixed component GH. The sun gear SR4 of the fourth planetary gear set PG4 can be connected to the second transmission input shaft GE2 for shifting the reverse driving operation. The ring gear HR4 of the fourth planetary gear set PG4 is connected to the planet carrier PT2 of the second planetary gear set PG2.

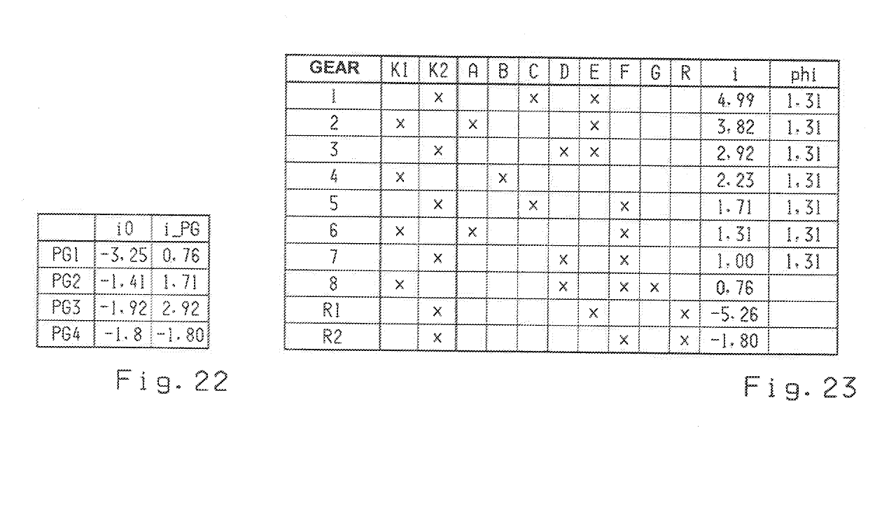

FIGS. 22 and 23 show one possible transmission ratio pattern and a shift pattern of this transmission structure according to FIG. 21. Thus, the fourth planetary gear set PG4 has a lower transmission ratio with i_PG=−1.8 in comparison with the transmission ratio pattern according to FIG. 17 of the transmission structures according to FIG. 16 and FIG. 19. The shift pattern in FIG. 23 shows that it is possible to shift to two reverse gears R1 R2, whose transmission ratios correspond approximately to the transmission ratios of the respective forward gears (first gear “1” and/or fifth gear “5”).

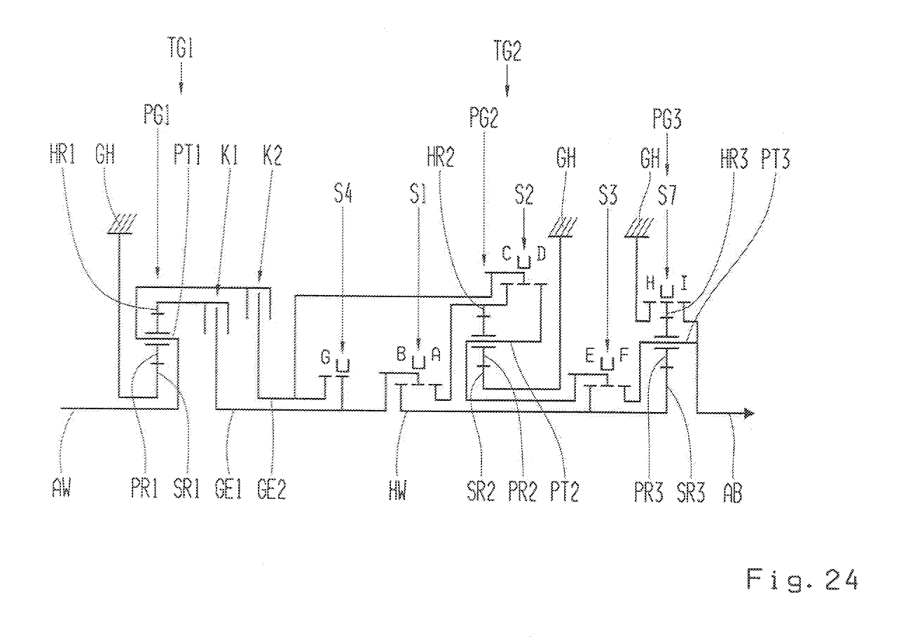

FIG. 24 shows a transmission with a design similar to that of FIG. 4, but an additional shift element S7 with two shift positions H, I is situated therein in this case, to alternately connect its ring gear HR3 to the rotationally fixed component GH or to the planet carrier PT3 with the third planetary gear set PG3. Therefore, this third planetary gear set PG3 may optionally be in direct drive.

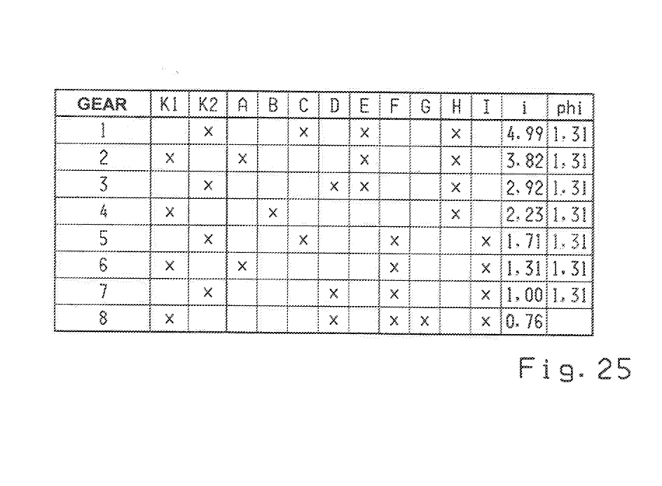

In a respective shift pattern shown in FIG. 25, which corresponds largely to the shift pattern according to FIG. 5, the active transmission ratio of the third planetary gear set PG3 is thus shifted in the lower four forward gears “1” through “4” in that the ring gear HR3 of the third planetary gear set PG3 is locked. The third planetary gear set PG3 has direct drive in the four higher forward gears “5” through “8.”

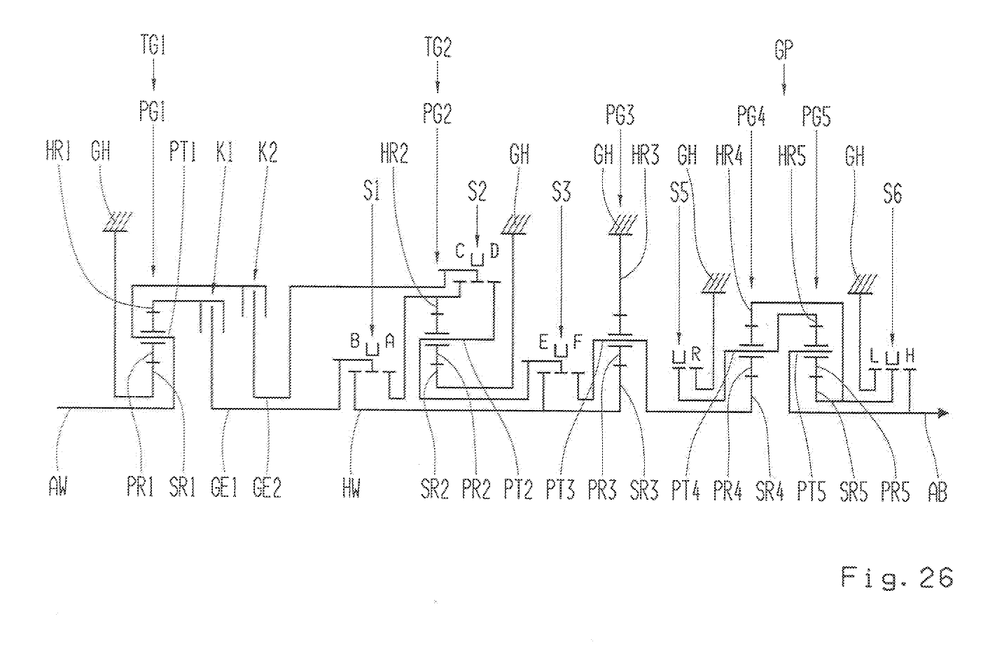

FIG. 26 shows an enlargement of the transmission structure presented so far to form a group transmission. To do so, a range group GP is situated downstream from the third planetary gear set PG3, both axially and with regard to the drive technology. This range group GP has a fourth planetary gear set PG4, which is designed as a reversing gear set, a fifth shift element S5 having a single shift position R is assigned to this planetary gear set for shifting a reverse gear group, as well as a fifth planetary gear set PG5, to which a sixth shift element S6 having two shift positions L, H is assigned for shifting between a slow forward gear group and a fast forward gear group.

The ring gear HR4 of the fourth planetary gear set PG4 is connected to the sun gear SR5 of the fifth planetary gear set PG5. The planet carrier PT4 of the fourth planetary gear set PG4 is connected to the ring gear HR5 of the fifth planetary gear set PG5 and together with it can be locked on the rotationally fixed component GH by the fifth shift element S5 for shifting the reverse driving function. The sun gear SR4 of the fourth planetary gear set PG4 is connected to the planet carrier PT3 of the third planetary gear set PG3. In addition, the sun gear SR5 of the fifth planetary gear set PG5, which is connected to the ring gear HR4 of the fourth planetary gear set PG4, can be locked on the rotationally fixed component GH by the sixth shift element S6 for shifting a lower gear group and can be connected to the planet carrier PT5 of the fifth planetary gear set PG5 for shifting an upper gear group, so that the fifth planetary gear set PG5 is blocked. With this transmission structure, a fourth shift element S4 for shifting a subtransmission coupling is omitted. Accordingly, the main transmission of the transmission structure according to FIG. 26 corresponds to that of the seven-gear transmission according to FIG. 7.

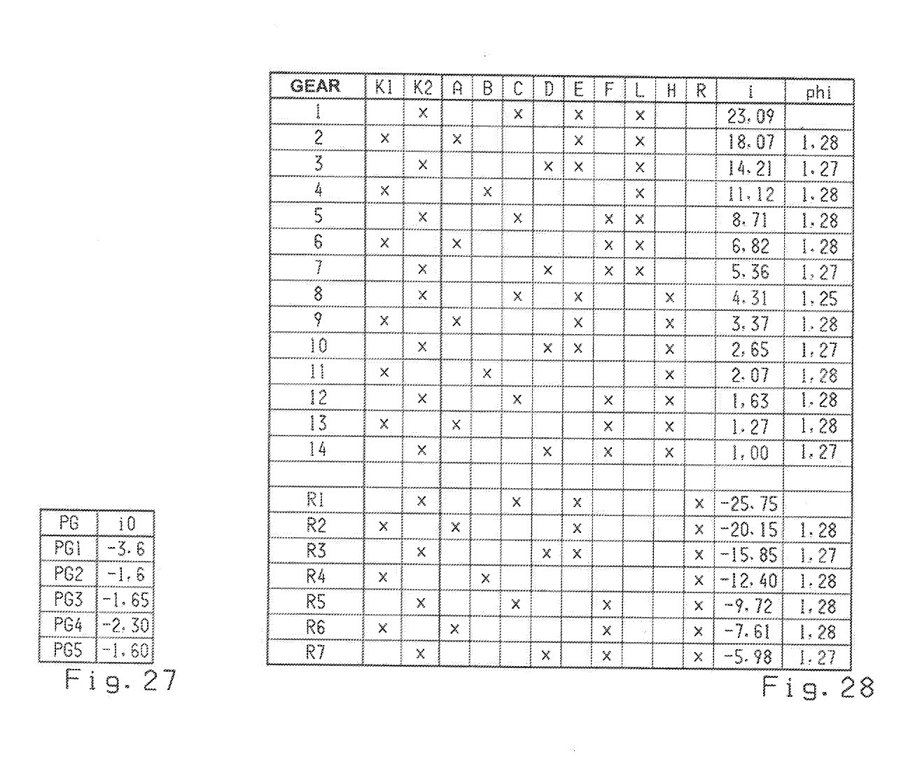

FIG. 27 shows one possible transmission ratio table with stationary transmission ratios i_0 of the five planetary gear sets PG1, PG2, PG3, PG4, PG5. FIG. 28 shows one possible resulting shift pattern. According to this, the number of gears of the main transmission is doubled, so that it is possible to shift to a total of 14 forward gears “1” through “14” and seven reverse gears R1 through R7. The highest forward gear “14” is designed as a direct gear.

There is an interruption in tractive force when shifting the range group GP between seventh gear “7” and eighth gear “8” because the second decoupling element K2 is engaged in these two gears. The gear increment phi between these two gears “7” and “8” is therefore designed to be somewhat smaller. All the other gear changes are power shiftable. Due to the upshifted transmission ratio of the fifth planetary gear set PG5, the seven forward gears “1” through “7” in the lower gear group and the seven reverse gears R1 through R7 have very low transmission ratios. The transmission according to FIG. 26 permits very low speeds for maneuvering and is therefore suitable for commercial vehicles in particular.

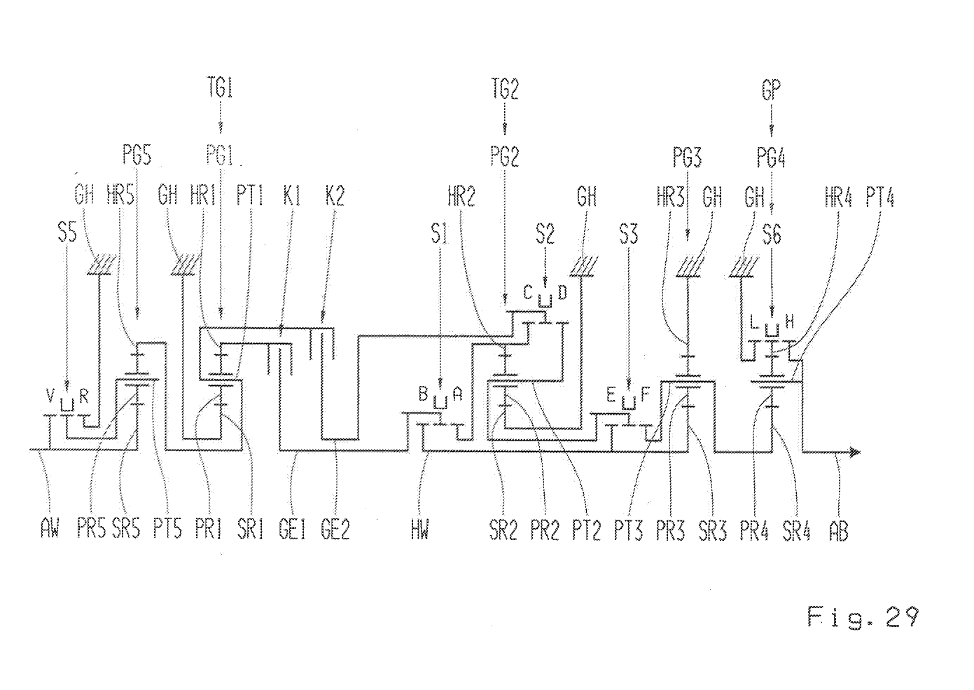

FIG. 29 shows a second embodiment of a group transmission. With this transmission, a range group GP comprises a fourth planetary gear set PG4 and a sixth shift element S6 with two shift positions L, H for changing between a slow forward gear group and a fast forward gear group. A fifth planetary gear set PG5 is situated as a splitter group. Furthermore, a fifth shift element S5 with two shift positions V, R is provided for changing between a forward driving operation and a reverse driving operation.

The fifth planetary gear set PG5, or the splitter group PG5, respectively is comparable to the upstream planetary gear set PG4 of the transmission according to FIG. 16. The ring gear HR5 of the fifth planetary gear set PG5 is connected to the planet carrier PT1 of the first planetary gear set PG1. The sun gear SR5 of the fifth planetary gear set PG5 is connected to the drive shaft AW. The planet carrier PT5 of the fifth planetary gear set PG5 is alternately connectable by the fifth shift element S5 in its first shift position V to the drive shaft AW or can be locked on the rotationally fixed component GH in its second shift position R. By connecting the planet carrier PT5 of the fifth planetary gear set PG5 to the drive shaft AW, it is simultaneously connected to the sun gear SR5 of the fifth planetary gear set PG5, so that the fifth planetary gear set PG5 has direct drive in forward driving operation. By locking the planet carrier PT5 of the fifth planetary gear set PG5, the minus stationary transmission ratio of the fifth planetary gear set PG5 is active, so that the direction of rotation reverses between the driving sun gear SR5 and the ring gear HR 5 on the output end, for a reverse driving operation.

With the fourth planetary gear set PG4 of the transmission according to FIG. 29, which acts as a range group GP, the sun gear SR4 of the fourth planetary gear set PG4 is connected to the planet carrier PT3 of the third planetary gear set PG3. The ring gear HR4 of the fourth planetary gear set PG4 can be alternately locked on the rotationally fixed component GH by means of the sixth shift element 86, so that the transmission ratio of the fourth planetary gear set PG4 is activated, or connected to the planet carrier PT4 of the fourth planetary gear set PG4, so that the direct drive of the fourth planetary gear set PG4 is activated.

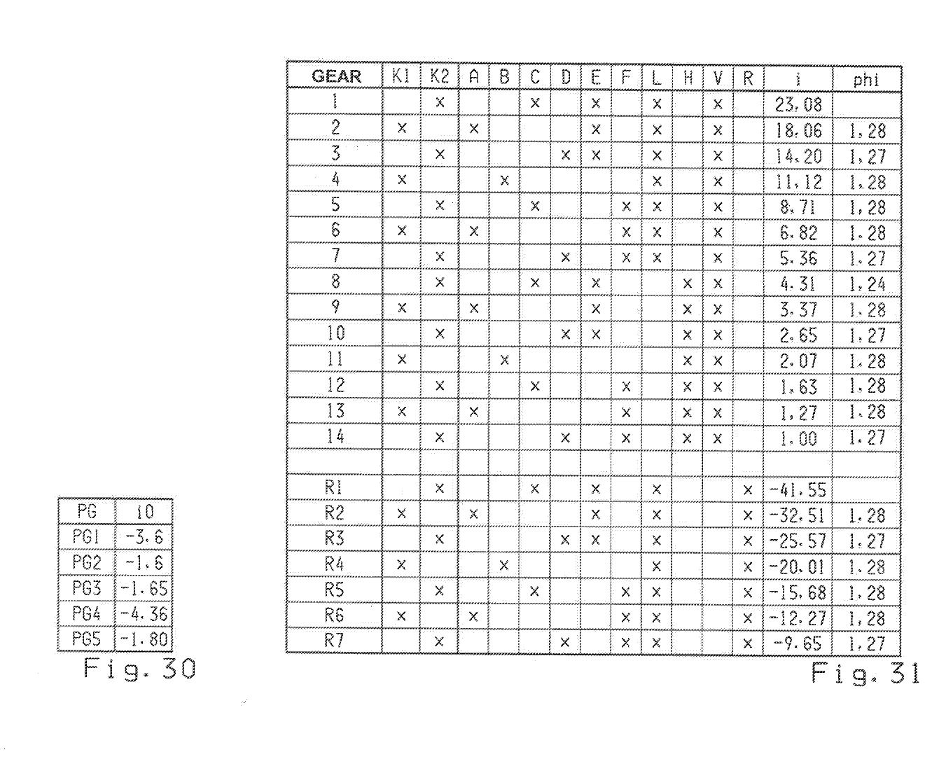

FIG. 30 shows, as a numerical example, one possible transmission ratio table with stationary transmission ratios i_0 of the five planetary gear sets PG1, PG2, PG3, PG4, PG5. FIG. 31 shows a resulting possible shift pattern, according to which 14 forward gears “1” to “14” and seven reverse gears R1 to R7 are implemented. The transmission ratios of the forward gears “1” to “14” are comparable to those of the shift pattern according to FIG. 28 of the group transmission according to FIG. 26. However, the reverse gears R1 to R7 have an even lower transmission ratio. The transmission ratios correspond to approximately 1.8 times the corresponding forward gears. This transmission is therefore suitable in particular for a very sensitive maneuvering operation.

### LIST OF REFERENCE NOTATION

A, B, C, D, E, F Shift positions
G, H, I, L, R, V Shift positions
AB Output shaft
B1 Decoupling element, brake
AW Drive shaft
EM Electric machine
EMR Rotor of the electric machine EM
GE1 First transmission input shaft
GE2 Second transmission input shaft
GH Rotationally fixed component, casing
GP Range group
HR1, HR2, HR3 Ring gears
HR4, HR5 Ring gears
HW Main shaft
K1, K2 Decoupling elements, friction clutches
PG1, PG2, PG3 Planetary gear sets
PG4, PG5 Planetary gear sets
PR1, PR2, PR3 Planet gears
PR4, PR5 Planet gears
PT1, PT2, PT3 Planet carriers
PT4, PT5 Planet carriers
R1, R2, R3, R4 Reverse gears
R5, R6, R7, R8 Reverse gears
S1, S2, S3, S4 Shift elements
S5, S6, S7 Shift elements
SR1, SR2, SR3 Sun gears
SR4, SR5 Sun gears
TG1, TG2 Subtransmission
X1 Decoupling element, form-locking clutch
i Gear transmission ratio
i0 Stationary transmission ratio of the planetary gear sets
PG Planetary gear set transmission ratio
phi Gear increment
“1”to “14” Forward gear

1-17. (canceled)

18. A vehicle transmission comprising:
a drive shaft (AW) having first and second transmission input shafts (GE1, GE2), and at least one decoupling element (K2, X1) being assigned to the second transmission input shaft (GE2);
a main shaft (HW);
an output shaft (AB);
at least first, second and third planetary gear sets (PG1, PG2, PG3), each of the first planetary gear set, the second planetary gear set and the third planetary gear set having, as planetary elements, at least a ring gear (HR1, HR2, HR3), a sun gear (SR1, SR2, SR3) and a planet carrier (PT1, PT2, PT3) with planet gears (PR1, PR2, PR3);
a plurality of shift elements (S1, S2, S3, S4, S5, S6, S7) for shifting either gear transmission ratios or driving connections;
wherein a first subtransmission (TG1) is assigned to the first transmission input shaft (GE1) and a second subtransmission (TG2) is assigned to the second transmission input shaft (GE2), one of the first and the second subtransmissions (TG1, TG2) has at least the first planetary gear set (PG1) and the other of the first and the second subtransmissions (TG1, TG2) has at least the second planetary gear set (PG2),
the first planetary gear set (PG1) is situated upstream of the first and the second transmission input shafts (GE1, GE2) with regard to a drive technology;
a first one of the planetary elements (HR1, PT1, SR1) of the first planetary gear set (PG1), which is active as a drive element of the first planetary gear set (PG1), is either connected or connectable, either directly or indirectly, at a drive end to the drive shaft (AW) and is connectable, at a transmission end, to the second transmission input shaft (GE2) by the at least one decoupling element (K2, X1);
a second one of the planetary elements (HR1, PT1, SR1) of the first planetary gear set (PG1), which is active as an output element of the first planetary gear set (PG1), is either connected or connectable, at the transmission end, to the first transmission input shaft (GE1);
the first transmission input shaft (GE1) is connectable to either the second transmission input shaft (GE2) or at least to the main shaft (HW), the first and the second transmission input shafts (GE1, GE2) are each operatively connected to either one or both of the second and the third planetary gear sets (PG2, PG3);
the main shaft (HW) is connected to either the output shaft (AB) or to at least one of the planetary elements (HR3, PT3, SR3) of the third planetary gear set (PG3); and
at least seven sequentially power shiftable forward gears (“1,” “2,” “3,” “4,” “5,” “6,” “7”) are shiftable by the first and the second subtransmissions (TG1, TG2), and one of the at least seven forward gears is either a direct gear or an overdrive gear.

19. The vehicle transmission according to claim 17, wherein the vehicle transmission is designed as a double clutch transmission, with a first decoupling element (K1), which is designed as a first friction clutch (K1), and a second decoupling element (K2), which is designed as a second friction clutch (K2);
the first friction clutch (K1) is connected, at an input end thereof, to the ring gear (HR) of the first planetary gear set (PG1), which is active as the output element of the first planetary gear set (PG1);
the first friction clutch (K1) is connected, at an output end thereof, to the first transmission input shaft (GE1);
the second friction clutch (K2) is connected, at an input end thereof, to the planet carrier (PT1) of the first planetary gear set (PG1), which is active as the drive element of the first planetary gear set (PG1), and the second friction clutch (K2) is connected, at an output end thereof, to the second transmission input shaft (GE2).

20. The vehicle transmission according to claim 18, wherein the first, the second and the third planetary gear sets (PG1, PG2, PG3) are shiftable by first, second, third and fourth shift elements (S1, S2, S3, S4);
each of the first, the second and the third shift elements has two shift positions (A, B; C, D; E, F) and the fourth shift element (S4) has one shift position (G),
the ring gear (HR1) of the first planetary gear set (PG1) is connectable, by the first decoupling element (K1), to the first transmission input shaft (GE1); the sun gear (SR1) of the first planetary gear set (PG1) is either locked or lockable to a rotationally fixed component (GH); and the planet carrier (PT1) of the first planetary gear set (PG1) is connectable, by the second decoupling element (K2), to the second transmission input shaft (GE2);
the ring gear (HR2) of the second planetary gear set (PG2) is connectable, via the first shift element (S1), to the first transmission input shaft (GE1) and, via the second shift element (S2), to the second transmission input shaft (GE2); the sun gear (SR2) of the second planetary gear set (PG2) is either locked or lockable on the rotationally fixed component (OH); and the planet carrier (P12) of the second planetary gear set (PG2) is connectable, via the second shift element (S2), to the second transmission input shaft (GE2), and, via the third shift element (S3) to the planet carrier (PT3) of the third planetary gear set (PG3);
the ring gear (HR3) of the third planetary gear set (PG3) is either locked or lockable to the rotationally fixed component (GH); the sun gear (SR3) of the third planetary gear set (PG3) is connectable, via the third shift element (S3), to the planet carrier (PT2) of the second planetary gear set (PG2), and, via the first shift element (S1), to the first transmission input shaft (GE1); and the planet carrier (PT3) of the third planetary gear set (PG3) is connected to the output shaft (AB);
the main shaft (HW) is directly connected to the output shaft (AB);
eight forward gears (“1,” “2” “3,” “4,” “5,” “6,” “7,” “8”) are shiftable and are sequentially power shiftable by the first and the second decoupling elements (K1, K2), a seventh forward gear (“7”) is shiftable as a direct gear and is shiftable by the second decoupling element (K2), the second shift element (S2) and the third shift element (S3); and
an eighth forward gear (“8”) is shiftable, as an overdrive gear, and is shiftable by the first decoupling element (K1) and the fourth shift element (S4), and a direct connection of the first transmission input shaft (GE1) to the main shaft (HW) is established by the fourth shift element (S4).

21. The vehicle transmission according to claim 18, wherein the first, the second and the third planetary gear sets (PG1, PG2, PG3) are shiftable by first, second, third and fourth shift elements (S1, S2, S3, S4), each of the first, the second and the third shift elements has two shift positions (A, B; C, D; E, F) and the fourth shift element (S4) has one shift position (G);
the ring gear (HR1) of the first planetary gear set (PG1) is connectable, by the first decoupling element (K1), to the first transmission input shaft (GE1); the sun gear (SR1) of the first planetary gear set (PG1) is either locked or lockable to a rotationally fixed component (GH); and the planet carrier (PT1) of the first planetary gear set (PG1) is connectable, by the second decoupling element (K2), to the second transmission input shaft (GE2);
the ring gear (HR2) of the second planetary gear set (PG2) is connectable, by the first shift element (S1), to the first transmission input shaft (GE1) and is connectable, by the second shift element (S2), to the second transmission input shaft (GE2); the sun gear (SR2) of the second planetary gear set (PG2) is either locked or lockable to the rotationally fixed component (GH); and the planet carrier (PT2) of the second planetary gear set (PG2) is connectable, by the second shift element (S2), to the second transmission input shaft (GE2), and is connectable, by the third shift element (S3), to the planet carrier (PT3) of the third planetary gear set (PG3);
the ring gear (HR3) of the third planetary gear set (PG3) is either locked or lockable to the rotationally fixed component (GH); the sun gear (SR3) of the third planetary gear set (PG3) is connectable, by the third shift element (S3), to the planet carrier (PT2) of the second planetary gear set (PG2) and is connectable, by the first shift element (S1), to the first transmission input shaft (GE1); and the planet carrier (PT3) of the third planetary gear set (PG3) is connected to the output shaft (AB);
the main shaft (HW) is connected to the sun gear (SR3) of the third planetary gear set (PG3);
eight forward gears (“1,” “2,” “3,” “4,” “5,” “6,” “7,” “8”) are sequentially power shiftable by the first and the second decoupling elements (K1, K2);
a seventh gear (“7”) is shiftable as a direct gear and is shiftable by the second decoupling element (K2), the second shift element (S2), and the third shift element (S3);
an eighth gear (“8”) is shiftable as an overdrive gear and is shiftable by the first decoupling element (K1) and the second the third and the fourth shift elements (S2, S3, S4); and
the first transmission input shaft (GE1) is connectable, via the fourth shift element (S4), to the second transmission input shaft (GE2).

22. The vehicle transmission according to claim 18, wherein the first, the second and the third planetary gear sets (PG1, PG2, PG3) are shiftable by first, second, and third shift elements (S1, S2, 33), each of the first, the second and the third shift elements has two shift positions (A, B; C, D; E, F);
the ring gear (HR1) of the first planetary gear set (PG1) is connectable, by the first decoupling element (K1), to the first transmission input shaft (GE1); the sun gear (SR1) of the first planetary gear set (PG1) is either locked or lockable on a rotationally fixed component (GH); and the planet carrier (PT1) of the first planetary gear set (PG1) is connectable, by the second decoupling element (K2), to the second transmission input shaft (GE2);
the ring gear (HR2) of the second planetary gear set (PG2) is connectable, by the first shift element (S1), to the first transmission input shaft (GE1) and is connectable, by the second shift element (S2), to the second transmission input shaft (GE2); the sun gear (SR2) of the second planetary gear set (PG2) is either locked or lockable on the rotationally fixed component (GH); and the planet carrier (PT2) of the second planetary gear set (PG2) is connectable, by the second shift element (S2), to the second transmission input shaft (GE2) and is connectable, by the third shift element (S3), to the planet carrier (PT3) of the third planetary gear set;
the ring gear (HR3) of the third planetary gear set (PG3) is either locked or lockable to the rotationally fixed component (GH); the sun gear (SR3) of the third planetary gear set (PG3) is connectable, by the third shift element (S3), to the planet carrier (PT2) of the second planetary gear set (PG2) and is connectable, by the first shift element (S1), to the first transmission input shaft (GE): and the planet carrier (PT3) of the third planetary gear set (PG3) is connected to the output shaft (AB);
the main shaft (HW) is connected to the sun gear (SR3) of the third planetary gear set (PG3);
seven forward gears (“1,” “2,” “3,” “4,” “5,” “6,” “7”) are shiftable and are sequentially power shiftable by the first and the second decoupling elements (K1, K2), and a seventh gear (“7”) is a direct gear and is shiftable by the second decoupling element (K2) and the second and the third shift elements (S2, S3).

23. The vehicle transmission according to claim 18, wherein another shift element (S7), by which the ring gear (HR3) of the third planetary gear set (PG3) is either releasably lockable to a rotationally fixed component (GH) or is connectable to the planet carrier (PT3), is situated therein.

24. The vehicle transmission according to claim 18, wherein a first shift element (S1) and a fourth shift element (S4) are combined with one another into a single shift element (S1/S4) which has three shift positions (A, B, G).

25. The vehicle transmission according to claim 18, wherein the second planetary gear set (PG2) is situated radially above the third planetary gear set (PG3), and the second and the third planetary gear sets (PG2, PG3) are axially nested inside one another.

26. The vehicle transmission according to claim 18, wherein a first decoupling element (B1) and a second decoupling element (K2) are situated in the vehicle transmission, the first decoupling element (B1) is a brake by which the sun gear (SR1) of the first planetary gear set (PG1) is either braked to a rotationally fixed component (GH) or is releasable from the rotationally fixed component (GH);
the second decoupling element (K2) is a friction clutch, which is connected at an input end thereof to the planet carrier (PT1) of the first planetary gear set (PG1), which is active as its drive element, and is connected, at an output end thereof, to the second transmission input shaft (GE2); and
the ring gear (HR1) of the first planetary gear set, which is active as an output element of the first planetary gear set, is connected to the first transmission input shaft (GE1).

27. The vehicle transmission according to claim 18, wherein, to implement up to eight reverse gears (R1, R2, R3, R4, R5, R6, R7, R8), a fourth planetary gear set (PG4), which is active as a reversing gear set, and a fifth shift element (S5), which has two shift positions (R, V), are both situated axially in front of the first planetary gear set (PG1) and are arranged upstream from the first planetary gear set (PG1) with regard to the drive technology;
a ring gear (HR4) of the fourth planet gear (PG4) is connected to the planet carrier (PT1) of the first planetary gear set (PG1); a sun gear (SR4) of the fourth planet gear (PG4) is connected to the drive shaft (AVV), and a planet carrier (PT4) of the fourth planet gear (PG4) is either lockable, by the fifth shift element (S5), to the rotationally fixed component (GH) or is connectable to the sun gear (SR4) of the fourth planetary gear set (PG4).

28. The vehicle transmission according to claim 18, wherein, for implementation of up to four reverse gears (R1, R2, R3, R4), a fourth planetary gear set (PG4), which is active as a reversing gear set, and a fifth shift element (S5), which has two shift positions (R, V), are both situated axially between the first planetary gear set (PG1) and the second planetary gear set (PG2) and are arranged upstream from the second planetary gear set (PG2) with regard to the drive technology;
a ring gear (HR4) of the fourth planet gear (PG4) is connectable to either the ring gear (HR2) or the planet carrier (PT2) of the second planetary gear set (PG2) by the second shift element (S2); a sun gear (SR4) of the fourth planetary gear set (PG4) is connected to the second transmission input shaft (GE2), and a planet carrier (PT4) of the fourth planet gear (PG4) is either lockable, by the fifth shift element (S5), to the rotationally fixed component (GH) or is connectable to the sun gear (SR4) of the fourth planetary gear set (PG4).

29. The vehicle transmission according to claim 18, wherein, for implementation of either one or two reverse gears (R1, R2) a fourth planetary gear set (PG4), which is active as a reversing gear set, and a fifth shift element (S5), which has one shift position (R), are both situated axially between the second planetary gear set (PG2) and the third planetary gear set (PG3) and are situated downstream from the second planetary gear set (PG2) with regard to the drive technology;
the fifth shift element (S5) and a second shift element (S2) are combined with one another into a single shift element (S2/S5) which has three shift positions (C, D, R);
a ring gear (HR4) of the fourth planetary gear set (PG4) is connected to the planet carrier (PT2) of the second planetary gear set (PG2); a sun gear (SR4) of the fourth planetary gear set (PG4) is connectable, by the fifth shift element (S5), to the second transmission input shaft (GE2), and a planet carrier (PT4) of the fourth planetary gear set (PG4) is either locked or lockable to the rotationally fixed component (GH) together with the sun gear (SR4) of the second planetary gear set (PG2).

30. The vehicle transmission according to claim 18, wherein the vehicle transmission is a hybrid transmission, with which the second transmission input shaft (GE2) is drive-connected to a rotor (EMR) of an electric machine (EM);
a first decoupling element (K1) and a second decoupling element (X1) are situated in the vehicle transmission, the first decoupling element (K1) is a friction clutch by which the drive shaft (AW) is connectable to the planet carrier (PT1) of the first planetary gear set (PG1), which is active as the drive element of the first planetary gear set (PG1), and the second decoupling element (X1) is a form-locking clutch, by which the planet carrier (PT1) of the first planetary gear set (PG1) is connectable, at the transmission end, to the second transmission input shaft (GE2).

31. The vehicle transmission according to claim 18, wherein the vehicle transmission is a hybrid transmission, with which the second transmission input shaft (GE2) is operatively connected to a rotor (EMR) of an electric machine (EM), a first decoupling element (X1), which is designed as a form-locking clutch, is situated in the hybrid transmission, and the planet carrier (PT1) of the first planetary gear set (PG1) is connectable, by the first decoupling element (X1), at a transmission end to the second transmission input shaft (GE2), and the drive shaft (AW) is connected, via the first decoupling element (X1), to the planet carrier (PT1) of the first planetary gear set (PG1), which is active as the drive element of the first planetary gear set (PG1).

32. The vehicle transmission according to claim 30, wherein the second decoupling element (X1), which is designed as a form-locking clutch, and a fourth shift element (S4) are combined with one another as a single shift element (S41X1) which has two shift positions (G. X) by which either the planet carrier (PT1) of the first planetary gear set (PG1) is connectable to the second transmission input shaft (GE2) at the transmission end, or the first transmission input shaft is connectable to the second transmission input shaft (GE1, GE2).

33. The vehicle transmission according to claim 18, wherein the vehicle transmission is a double clutch group transmission, with which the first, the second and the third planetary gear sets (PG1, PG2, PG3) are each shiftable by at least one first, second and third shift element (S1, S2, S3) having two shift positions (A, B, C, D, E, F);
a range group (GP) is situated downstream from the third planetary gear set (PG3) with regard to the drive technology;
a fourth planetary gear set (PG4), which is embodied as a reversing gear set and to which a fifth element (S5) with one shift position (R) is assigned for shifting a reverse gear group;
a fifth planetary gear set (PG5), to which a sixth shift element (S6) with two shift positions (L, H) is assigned, for shifting between a slow forward gear group and a fast forward gear group;
a ring gear (HR4) of the fourth planetary gear set (PG4) is connected to a sun gear (SR5) of the fifth planetary gear set (PG5); a sun gear (SR4) of the fourth planetary gear set (PG4) is connected to the planet carrier (PT3) of the third planetary gear set (PG3); and a planet carrier (PT4) of the fourth planetary gear set (PG4) is connected to a ring gear (HR5) of the fifth planet gear set (PG5) and is lockable, by the fifth shift element (S5), to the rotationally fixed component (GH);
the sun gear (SR5) of the fifth planetary gear set (PG5) is either lockable, by the sixth shift element (S6), to the rotationally fixed component (GH) or is connectable to the planet carrier (PT5), and a planet carrier (PT5) of the fifth planetary gear set (PG5) is connected to the output shaft (AB);
at least 14 forward gears (“1” through “14”) and at least seven reverse gears (R1 to R7) are shiftable by the first, the second, the third, the fourth and the fifth shift elements (S1, S2, S3, S5, S6) with a total of nine shift positions (A, B, C, D, E, F, H, L, R);
at least 13 forward gears, of the at least 14 forward gears (“1” through “14”), are power shiftable, a remaining one of the at least 14 forward gears (“14”) is a direct gear, and the at least seven reverse gears (R1 through R7) are all power shiftable.

34. The vehicle transmission according to claim 18, wherein the vehicle transmission is a double clutch group transmission with which the first, the second and the third planetary gear sets (PG1, PG2, PG3) are shiftable by at least one first, second and third shift element (S1, S2, S3), which each have two shift positions (A, B, C, D, E, F);
a fourth planetary gear set (PG4), which is active as a range group (GP), and a sixth shift element (S6), which has two shift positions (L, H) for shifting between a slow forward gear group and a fast forward gear group, are situated downstream from the third planetary gear set (PG3) with respect to the drive technology;
a ring gear (HR4) of the fourth planetary gear set (PG4) is either lockable to the rotationally fixed component (GH) or is connectable to a planet carrier (PT4) of the fourth planetary gear set (PG4); a sun gear (SR4) of the fourth planetary gear set (PG4) is connected to the planet carrier (PT3) of the third planetary gear set (PG3); and
a planet carrier (PT4) of the fourth planetary gear set (PG4) is connected to the output shaft (AB);
a fifth planetary gear set (PG5), which is active as a reversing gear set, and a fifth shift element (S5), which has two shift positions (R, V), are situated upstream from the first planetary gear set (PG1) with regard to the drive technology;
a ring gear (HR5) of the fifth planetary gear set (PG5) is connected to the planet carrier (PT1) of the first planetary gear set (PG1); a sun gear (SR5) of the fifth planetary gear set (PG5) is connected to the drive shaft (AW); and a planet carrier (PT5) of the fifth planetary gear set (PG5) is either lockable, by the fifth shift element (S5), to the rotationally fixed component (GH) or is connectable to the sun gear (SR5) of the fifth planetary gear set (PG5);
at least 14 forward gears (“1” through “14”) and at least seven reverse gears (R1 to R7) are shiftable by the first, the second, the third, a fourth and the fifth shift elements (S1, S2, S3, S5, S6), by a total of ten shift positions (A, B, C, D, E, F, H, L, R, V);
at least 13, of the at least 14 forward gears (“1” through “14”), are power shiftable, a remaining one of the at least fourteen forward gears (“14”) is a direct gear, and the at least seven reverse gears (R1 to R7) are all power shiftable.

35. A vehicle transmission comprising:
a drive shaft (AW), first and second transmission input shafts (GE1, GE2), a main shaft (HW), and an output shaft (AB);
at least one decoupling element (K2, X1);
at least first, second and third planetary gear sets (PG1, PG2, PG3), each of the first, the second and the third planetary gear sets comprising planetary elements, the planetary elements of each of the first, the second and the third planetary gear sets are a ring gear (HR1, HR2, HR3), a sun gear (SR1, SR2, SR3), and a planet carrier (PT1, PT2, PT3) which supports a plurality of planet gears (PR1, PR2, PR3);
a plurality of shift elements (S1, S2, S3, S4, S5, S6, S7) are shiftable for shifting gear transmission ratios or engaging driving connections;
first and second subtransmissions (TG1, TG2), the first subtransmission being assigned to the first transmission input shaft and the second subtransmission being assigned to the second transmission input shaft, the first subtransmission comprises at least the first planetary gear set, and the second subtransmission comprises at least the second planetary gear set;
the first planetary gear set being situated upstream from the first and the second transmission input shafts with regard to with regard to a flow of drive power;
a first one of the planetary elements (HR1 PT1 SR1) of the first planetary gear set (PG1) has a drive side that is connectable, as a drive input of the first planetary gear set, to the drive shaft for driving the first planetary gear set, and the first one of the planetary elements of the first planetary gear set has a transmission side that is connectable, via the at least one decoupling element, to the second transmission input shaft;
a second one of the planetary elements (HR1, PT1, SR1) of the first planetary gear set (PG1) has a drive output side that is connectable, as a drive output of the first planetary gearset, to the first transmission input shaft (GE1);
the first transmission input shaft (GE1) being connectable to either the second transmission input shaft or the main shaft (HW) such that the first and the second transmission input shafts are each operatively connected to either one or both of the second and the third planetary gear sets;
the main shaft being connected to either the output shaft or at least one of the planetary elements of the third planetary set; and
at least seven sequentially power shiftable forward gears (“1,” “2,” “3,” “4,” “5,” “6,” “7”) being implemented by the first and the second subtransmissions (TG1, TG2), and one of the at least seven forward gears is either a direct gear or an overdrive gear.
